(19) United States
(12) Patent Application Publication
(10) Pub. No.: US 2026/0352922 A1
(43) Pub. Date: Nov. 5, 2026

(54) INFORMATION PROCESSING SYSTEM, INFORMATION PROCESSING METHOD, AND INFORMATION PROCESSING PROGRAM

(71) Applicant: Sony Group Corporation, Tokyo (JP)

(72) Inventor: Keijiroh NAGANO, Tokyo (JP)

(73) Assignee: Sony Group Corporation, Tokyo (JP)

(21) Appl. No.: 19/571,624

(22) Filed: Mar. 19, 2026

(30) Foreign Application Priority Data
May 1, 2025 (JP) 2025-076165

(51) Int. Cl. H04N 21/4788

(52) U.S. Cl. CPC H04N 21/4788

(57) ABSTRACT

Provided is an information processing system including an acquisition unit that acquires comment information indicating a category of a comment added to a moving image and version information indicating a first version that is a version of the moving image, a determination unit that determines a level of the comment based on the category of the comment and the first version of the moving image, and an output unit that outputs comment display information indicating the comment whose display is changed according to the level.

### CROSS-REFERENCE TO RELATED APPLICATION

This application claims the benefit of Japanese Priority Patent Application JP 2025-076165 filed May 1, 2025, the entire contents of which are incorporated herein by reference.

### TECHNICAL FIELD

The present disclosure relates to an information processing system, an information processing method, and an information processing program.

### BACKGROUND

A technique for automatically generating content of a video (also referred to as a “moving image”) is provided. For example, a technique for estimating a three-dimensional posture of a virtual person from a two-dimensional line drawing and generating a moving image is provided (for example, PTL 1).

### CITATION LIST

### Patent Literature

PTL 1: JP 2003-058906 A

### SUMMARY

However, there is room for improvement in the technology in related art. For example, in related art, although a moving image can be generated from a storyboard, management of comments added to the moving image is not particularly considered. Thus, in the related art, it is difficult to determine which comment is to be emphasized when a user sees comments on the moving image, there is room for improvement in management of the comments, and it is desired to appropriately manage the comments on the moving image.

Accordingly, the present disclosure proposes an information processing system, an information processing method, and an information processing program that are capable of appropriately managing comments on a moving image.

According to an embodiment of the present disclosure, there is provided an information processing system including an acquisition unit that acquires comment information indicating a category of a comment added to a moving image and version information indicating a first version that is a version of the moving image, a determination unit that determines a level of the comment based on the category of the comment and the first version of the moving image, and an output unit that outputs comment display information indicating the comment whose display is changed according to the level.

### BRIEF DESCRIPTION OF DRAWINGS

FIG. 1 is a diagram illustrating an example of an information processing system according to an embodiment of the present disclosure.

FIG. 2 is a diagram illustrating an example of a hardware configuration of the information processing system according to the embodiment of the present disclosure.

FIG. 3 is a diagram illustrating a first processing example to be executed by the information processing system.

FIG. 4 is a diagram illustrating a second processing example to be executed by the information processing system.

FIG. 5 is a flowchart illustrating a processing procedure to be executed by the information processing system.

FIG. 6 is a flowchart illustrating a procedure related to version update processing to be executed by the information processing system.

FIG. 7 is a diagram illustrating a first configuration example of comment categories.

FIG. 8 is a diagram illustrating an example regarding determination of a comment level.

FIG. 9 is a diagram illustrating a second configuration example of comment categories.

FIG. 10 is a diagram illustrating another example regarding determination of a comment level.

FIG. 11 is a diagram illustrating an example of data management.

FIG. 12 is a diagram illustrating an example of processing according to modification categories.

FIG. 13 is a diagram illustrating an example of processing according to the modification categories.

FIG. 14 is a diagram illustrating an example of processing according to the modification categories.

FIG. 15 is a diagram illustrating an example of a display mode of comments.

FIG. 16 is a diagram illustrating an example of a display mode of versions.

FIG. 17 is a diagram illustrating an example of a display mode of versions.

FIG. 18 is a diagram illustrating an example of a display mode of versions.

FIG. 19 is a diagram illustrating an example of a display mode of versions.

FIG. 20 is a diagram illustrating an example of a display mode of versions.

FIG. 21 is a hardware configuration diagram illustrating an example of a computer that implements functions of an information processing apparatus.

### DESCRIPTION OF EMBODIMENTS

Embodiments of the present disclosure will be described below with reference to drawings. Note that the embodiments do not limit the information processing system, the information processing method, and the information processing program according to the present disclosure. In addition, in the following embodiments, the same components will be denoted by the same reference numerals or signs, and redundant description thereof will be omitted.

The present disclosure will be described in the order of the following items.

### 1. Embodiment

### 1-1. Overview of Configuration of Information Processing System According to Embodiment of Present Disclosure

### 1-2. Overview of Processing of Information Processing System

### 1-2-1. First Processing Example

### 1-2-2. Second Processing Example

### 1-3. Overview of Processing of Information Processing System

### 1-4. Processing Example

### 1-4-1. Comment Categories and Processing Example

### 1-4-1-1. First Configuration Example of Comment Categories

### 1-4-1-2. Second Configuration Example of Comment Categories

### 1-4-2. Data Management Example

### 1-4-3. Processing Example According to Modification Categories

### 1-4-4. Display Example of Comments

### 1-4-5. Display Example of Versions

### 1-5. AI Model

### 2. Other Embodiments

### 2-1. Other Configuration Examples

### 2-2. Others

### 3. Hardware Configuration

### 1. Embodiment

### 1-1. Overview of Configuration of Information Processing System According to Embodiment of Present Disclosure

In the following embodiment, a case where an information processing system 1 generates video data (also simply referred to as “video”) will be described, but generation of a video (also referred to as a “moving image”) may be performed by a system other than the information processing system 1, and the information processing system 1 may perform processing such as determination of a level of a comment (also referred to as a “comment level”) added to the generated moving image.

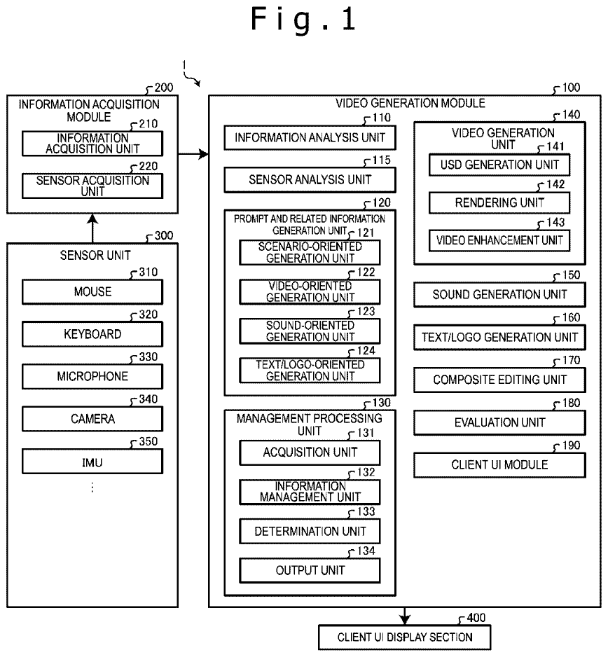

FIG. 1 is a diagram illustrating an example of an information processing system according to an embodiment of the present disclosure. The information processing system 1 includes a video generation module 100, an information acquisition module 200, a sensor unit 300, and a client UI display section 400. Note that although only one configuration for each portion is illustrated in FIG. 1, the information processing system 1 may include a plurality of video generation modules 100, a plurality of information acquisition modules 200, a plurality of sensor units 300, and a plurality of client UI display sections 400.

First, a configuration of the video generation module 100 that performs video generation processing will be described. The video generation module 100 includes an information analysis unit 110, a sensor analysis unit 115, a prompt and related information generation unit 120, a management processing unit 130, a video generation unit 140, a sound generation unit 150, a text/logo generation unit 160, a composite editing unit 170, an evaluation unit 180, a client UI module 190, and the like.

The information analysis unit 110 analyzes information. The information analysis unit 110 analyzes input text. For example, the information analysis unit 110 analyzes information input from the information acquisition module 200. The sensor analysis unit 115 analyzes input sensor information. For example, the sensor analysis unit 115 analyzes the sensor information acquired from the information acquisition module 200.

The prompt and related information generation unit 120 generates various types of information such as a prompt to be input to an artificial intelligence (AI) model (also simply referred to as a “model”) as a machine learning model, which will be described below. For example, the prompt and related information generation unit 120 generates various types of information to be used for generating a video (moving image) including a prompt and the like to be input to the model. For example, the prompt and related information generation unit 120 generates a prompt by using a user's input and a prompt (template thereof or the like) stored in advance. Note that the prompt is merely an example of information (model input information) to be input to the AI model, and the model input information to be input to the AI model is not limited to the prompt, and model input information in any form can be adopted, and the “prompt and related information generation unit” may be referred to as a “model input information or related information generation unit”. In FIG. 1, the prompt and related information generation unit 120 includes a scenario-oriented generation unit 121, a video-oriented generation unit 122, a sound-oriented generation unit 123, and a text/logo-oriented generation unit 124.

The scenario-oriented generation unit 121 generates various types of information related to the generation of a scenario. The scenario-oriented generation unit 121 generates input information to be input to a model that outputs a scenario. For example, the scenario-oriented generation unit 121 generates scenario data relating to moving image generation based on an input query. For example, the scenario-oriented generation unit 121 outputs scenario generation information to be used for generating scenario data based on an input query.

The video-oriented generation unit 122 generates various types of information relating to the generation of a video. The video-oriented generation unit 122 generates input information to be input to a model that outputs code for constructing three-dimensional (3D) data. For example, the video-oriented generation unit 122 generates code for constructing 3D data based on scenario data. For example, the video-oriented generation unit 122 outputs code generation information to be used for generating code for constructing 3D data based on scenario data.

The sound-oriented generation unit 123 generates various types of information relating to generation of sound information (audio information). The sound-oriented generation unit 123 generates input information to be input to a model that outputs sound. The text/logo-oriented generation unit 124 generates various types of information relating to generation of text and a logo. The text/logo-oriented generation unit 124 generates input information to be input to a model that outputs at least one of text and a logo.

The management processing unit 130 executes processing for managing information related to a moving image. The management processing unit 130 executes processing for managing versions of a moving image. For example, the management processing unit 130 executes processing for managing comments of a moving image. In FIG. 1, the management processing unit 130 includes an acquisition unit 131, an information management unit 132, a determination unit 133, and an output unit 134.

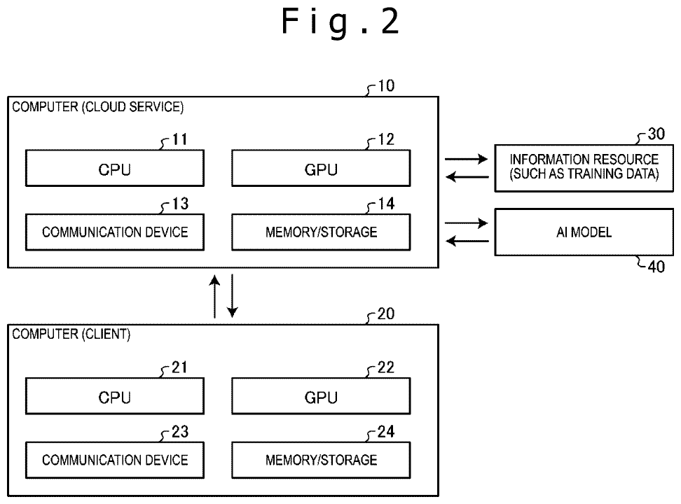

The acquisition unit 131 acquires various types of information through the information acquisition module 200. For example, the acquisition unit 131 acquires information to be used for processing relating to management of versions, comments, and the like from a storage unit (a memory/storage 14 or the like in FIG. 2) of the information processing system 1. The acquisition unit 131 acquires information such as designation information input by a keyboard 320 or a microphone 330. For example, the acquisition unit 131 acquires information such as designation information input by a user through the keyboard 320 or the microphone 330.

The acquisition unit 131 acquires comment information indicating a category of a comment (also referred to as a “comment category”) added to a moving image. For example, the comment categories include a plurality of categories including entirety, cast, cast motion (also simply referred to as “motion”), hand, cast position, camera framing, camera motion, background, and sound. The comment categories may also be a plurality of categories hierarchically structured according to the concept of each category. For example, the acquisition unit 131 acquires comment information indicating any one comment category among a plurality of categories including entirety, cast, motion, hand, cast position, camera framing, camera motion, background, and sound.

The acquisition unit 131 acquires version information indicating a first version that is a version of a moving image. For example, a first version is a version of a moving image when the moving image is displayed. The first version may also be the latest version of a moving image.

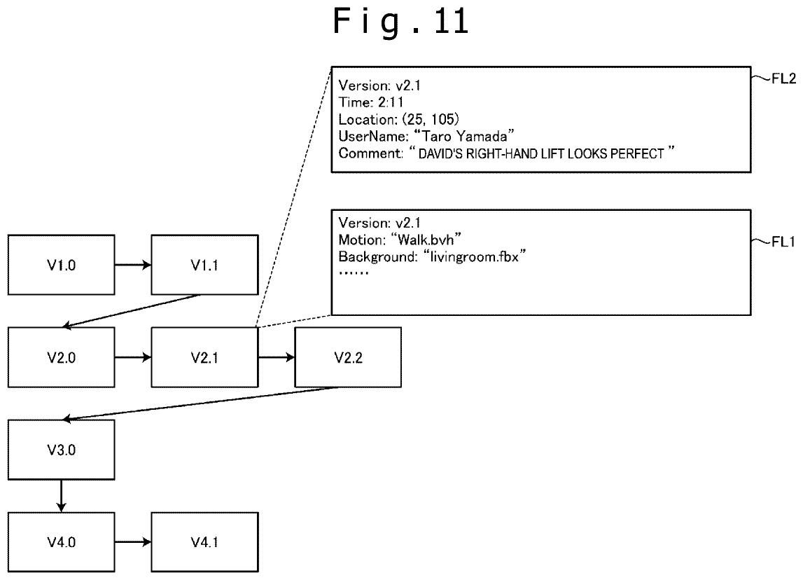

The information management unit 132 executes processing for managing information related to a moving image. The information management unit 132 manages information related to a version of a moving image. The information management unit 132 updates the version of a moving image in response to editing of the moving image. For example, the information management unit 132 generates management information (see FIG. 11 and the like) relating to the version. The information management unit 132 registers the management information related to the version in a storage unit (the memory/storage 14 or the like) of the information processing system 1.

The information management unit 132 updates the version of a moving image according to a modification to the moving image. For example, when a modification relating to a different category is made, the information management unit 132 updates a major version that is the highest-order level. Further, when a modification relating to the same category is made, the information management unit 132 updates a minor version that is a lower-order level relative to the major version.

In this manner, the version of the moving image is updated in response to the modification to the moving image. For example, when a moving image is modified in a different category, the major version that is the highest-order level is updated in the version of the moving image, and when a moving image is modified in the same category, the minor version that is the lower-order level relative to the major version is updated. In this manner, the information processing system 1 can appropriately manage information related to a moving image by updating the version of the moving image according to the modification of the moving image.

The determination unit 133 executes determination processing for determining information relating to a moving image. The determination unit 133 determines a level of a comment based on a category of the comment and a first version of a moving image. The determination unit 133 determines the level of the comment according to a difference between a second version, which is the version of the moving image when the comment is added, and the first version. In this manner, the information processing system 1 can appropriately manage comments on a moving image by determining the level of the comment according to the version of the moving image.

The determination unit 133 determines the level of the comment based on the modification of the moving image corresponding to the category between the second version and the first version. The determination unit 133 determines the level of the comment based on the number of modifications to the moving image corresponding to the category between the second version and the first version. In this manner, the information processing system 1 can appropriately manage comments on the moving image by determining the level of the comment according to the modification of the moving image. The determination unit 133 determines the level of the comment based on the number of modifications corresponding to the category in a period from the second version, which is a version before the first version, to the first version. The determination unit 133 determines the number of modifications corresponding to the category as the level of the comment.

The determination unit 133 determines the level of the comment based on a third version, which is a version subjected to the modification corresponding to the category. The determination unit 133 determines the level of the comment based on a weight corresponding to a difference between the first version and the third version. The determination unit 133 determines the level of the comment by using a calculation value calculated based on the weight corresponding to the difference between the first version and the third version and the number of modifications corresponding to the category in the third version. In this manner, the information processing system 1 can appropriately manage the comments on the moving image by determining the level of the comment according to the modifications corresponding to the category.

The output unit 134 outputs various types of information. The output unit 134 outputs information by transmitting the information. The output unit 134 transmits various types of information to the client UI display section 400. The output unit 134 transmits information related to the comment.

The output unit 134 outputs comment display information indicating a comment whose display has been changed according to the level. The output unit 134 outputs content including the comment display information and the moving image. The output unit 134 causes the comment display information to be displayed together with the moving image. For example, the output unit 134 transmits the content including the comment display information and the moving image to the client UI display section 400, thereby causing the client UI display section 400 to display the content including the comment display information and the moving image. In this manner, the information processing system 1 can appropriately output the comment on the moving image by changing the display of the comment display information according to the level.

The video generation unit 140 executes processing relating to generation of a video. The video generation unit 140 acquires moving image data based on code. The video generation unit 140 generates the video by using various types of information generated by the prompt and related information generation unit 120. For example, the video generation unit 140 generates the moving image data based on the code. Note that the video generation unit 140 may acquire the moving image data in any manner. For example, the video generation unit 140 may acquire moving image data by transmitting data to be used for generating the moving image data to an external service providing apparatus (vendor or the like) that provides a service of generating moving image data and receiving the moving image data generated by the service providing apparatus from the service providing apparatus. In FIG. 1, the video generation unit 140 includes a USD generation unit 141, a rendering unit 142, and a video enhancement unit 143.

The USD generation unit 141 generates various types of information relating to universal scene description (USD). For example, the USD generation unit 141 generates USD-Python or the like by an AI model such as a large language model (hereinafter also referred to as an “LLM”) by using the prompt obtained by the generation of a video-oriented prompt by the video-oriented generation unit 122. Note that the USD is merely an example, and information generated for a video is not limited to the USD, information in any form such as information of a 3D scene can be adopted, and the “USD generation unit” is read as a “video data generation unit”. The rendering unit 142 executes various types of processing relating to rendering. The rendering unit 142 executes processing of rendering the USD generated by the USD generation unit 141.

The video enhancement unit 143 executes various types of processing for enhancing a video. The video enhancement unit 143 enhances the quality of the generated video by video enhancement processing. For example, the video enhancement unit 143 executes image quality improvement processing of improving the image quality of moving image data.

The sound generation unit 150 executes processing of generating sound (audio). The sound generation unit 150 generates sound information such as background music (BGM), a sound effect (SE), narration, and lines by an AI model such as a contrastive learning model by using a prompt obtained by prompt generation for sound by the sound-oriented generation unit 123.

The text/logo generation unit 160 executes processing of generating at least one of text and a logo. The text/logo generation unit 160 generates at least one of text and a logo by using the information generated by the text/logo-oriented generation unit 124.

The video generation module 100 generates a prompt for scenario generation by combining a pre-stored prompt and a user's input through the above-described configuration. The video generation module 100 generates a scenario by inputting the generated prompt to an AI model such as an LLM. Further, the video generation module 100 generates a prompt for generating a video, sound, and text/logo from the generated scenario. The video generation module 100 performs video generation, sound generation, and text/logo generation by using a prompt, a scenario, and the like for generating a video, sound, and text/logo.

The composite editing unit 170 executes processing relating to editing. For example, the composite editing unit 170 executes processing of integrating (combining) the generated video, sound, and text/logo into one video.

The evaluation unit 180 executes evaluation processing for evaluating various targets. The evaluation unit 180 evaluates information generated by the above-described configuration. For example, the evaluation unit 180 generates information indicating evaluation of at least one of scenario data and moving image data.

The client UI module 190 executes processing relating to an output on a user interface (UI) on a client side. For example, the client UI module 190 generates various types of information relating to an output on the UI on the client side. In this case, the client UI module 190 executes processing for generating the UI to be displayed on the user side. The client UI module 190 generates various types of information to be displayed on the client UI display section 400. The client UI module 190 generates content. The client UI module 190 generates content including comment display information and a moving image. The client UI module 190 generates content to be displayed on the client UI display section 400.

Further, the information acquisition module 200 acquires various types of information. The information acquisition module 200 includes an information acquisition unit 210, a sensor acquisition unit 220, and the like. The information acquisition unit 210 is an acquisition unit that acquires information. For example, the information acquisition unit 210 acquires information to be used for processing from the storage unit (the memory/storage 14 or the like) of the information processing system 1. The information acquisition unit 210 acquires text information input by the keyboard 320 or the microphone 330. For example, the information acquisition unit 210 acquires text information input by the user through the keyboard 320 or the microphone 330. For example, the information acquisition unit 210 acquires an input query related to moving image generation from the user. The information acquisition unit 210 acquires information related to a comment on the moving image input by the user. For example, the information acquisition unit 210 acquires a comment on the moving image input by the user. The information acquisition unit 210 acquires a comment from the user added to the moving image. For example, the information acquisition unit 210 acquires a comment from the user received by the sensor unit 300. The sensor acquisition unit 220 acquires information (also referred to as “sensor information”) detected by a camera 340 or a sensor such as a motion capture sensor. The information acquisition module 200 provides (transmits) the acquired various types of information to the video generation module 100. Note that the information acquisition module 200 may be integrated with the video generation module 100.

The sensor unit 300 includes various sensors. The sensor unit 300 senses an input from a user. The sensor unit 300 receives an operation by the user. For example, the sensor unit 300 is a reception unit that receives an operation related to moving image editing from the user. For example, the sensor unit 300 includes a mouse 310, the keyboard 320, the microphone 330, the camera 340, an IMU 350 that is an inertial measurement device, and the like. As described above, the sensor unit 300 includes a user terminal (such as a smartphone) including the microphone 330, the camera 340, and the IMU 350, the sensor such as the motion capture sensor, and the like in addition to the mouse 310 and the keyboard 320, and senses the user's input.

The client UI display section 400 displays various types of information to be presented to a client (user). The client UI display section 400 displays the UI generated by the client UI module 190 on a display (display device) of the client. For example, the client UI display section 400 is a display control unit for displaying a storyboard based on scenario data. The storyboard is configured to display moving image data for each shot of the moving image.

For example, the client UI display section 400 functions as an output unit that outputs information related to a comment. The client UI display section 400 displays comment display information indicating a comment whose display has been changed according to the level. The client UI display section 400 displays content including the comment display information and the moving image. The client UI display section 400 displays the content received from the video generation module 100. The client UI display section 400 displays the comment display information together with the moving image.

The information processing system 1 may have a hardware configuration as illustrated in FIG. 2. FIG. 2 is a diagram illustrating a hardware configuration example of the information processing system according to the embodiment of the present disclosure. In FIG. 2, the information processing system 1 includes a computer 10 on the cloud side, a computer 20 on the client side, and the like as a hardware configuration. Further, the information processing system 1 may include an information providing apparatus (computer) that provides an information resource 30 such as training data and an AI model 40 to the computer 10.

Note that the hardware configuration illustrated in FIG. 2 is merely an example, and the information processing system 1 may employ any hardware configuration as long as desired processing can be executed. For example, the computer 10 and the computer 20 may be integrated with each other. The information resource 30 and the AI model 40 may be stored in the computer 10.

The computer 10 includes a central processing unit (CPU) 11, a graphics processing unit (GPU) 12, a communication device 13, and the memory/storage 14. For example, the computer 10 corresponds to the video generation module 100 and the information acquisition module 200 in FIG. 1. The computer 10 may be a service providing apparatus (server apparatus) that provides a video generation service. The CPU 11 and the GPU 12 are so-called processors, and execute calculation processing (arithmetic processing) relating to various types of processing such as video generation, for example.

Note that the above is merely an example, and the computer 10 may employ any configuration as long as desired processing can be executed. For example, the computer 10 may execute calculation processing (arithmetic processing) relating to various types of processing such as displaying a video by a circuit such as an application specific integrated circuit (ASIC) or a field programmable gate array (FPGA). The computer 10 may also be configured to directly incorporate the program into the circuit of the processor instead of storing the program in the memory (the memory/storage 14 or the like). In this case, the processor enables functions by reading and executing the program incorporated in the circuit. Note that each processor of the present embodiment is not limited to a case where each processor is configured as a single circuit, and a plurality of independent circuits may be combined to configure one processor and enable the function thereof. Further, similarly to the computer 10, the computer 20 may also employ any configuration as long as desired processing can be executed.

The communication device 13 is a communication device having a communication function for transmitting and receiving information to and from the computer 20, the information providing apparatus, and the like, and may be, for example, a communication circuit, a network interface card (NIC), or the like. The communication device 13 communicates with other apparatuses such as the computer 20 and the information providing apparatus via a predetermined network (the Internet or the like). For example, the communication device 13 is connected to the predetermined network in a wired or wireless manner, and transmits and receives information to and from other apparatuses such as the computer 20 and the information providing apparatus.

The memory/storage 14 is a storage device that stores various types of information. The memory/storage 14 is, for example, a semiconductor memory element such as a random access memory (RAM) or a flash memory or a storage device such as a hard disk or an optical disk. The memory/storage 14 stores various types of information to be used by a processor such as the CPU 11 or the GPU 12 for processing. The memory/storage 14 may store the information resource 30, the AI model 40, and the like.

The computer 20 includes a CPU 21, a GPU 22, a communication device 23, and a memory/storage 24. For example, the computer 20 corresponds to the client UI display section 400 in FIG. 1. The computer 20 may be a terminal apparatus (a personal computer (PC), a mobile device such as a smartphone, or the like) to be used by a user who uses the video generation service. The CPU 21 and the GPU 22 are so-called processors, and execute calculation processing (arithmetic processing) relating to various types of processing such as displaying a video, for example.

The communication device 23 is a communication device having a communication function for transmitting and receiving information to and from the computer 10 or the like, and may be, for example, a communication circuit, an NIC, or the like. The communication device 23 communicates with other apparatuses such as the computer 10 via a predetermined network (the Internet or the like). For example, the communication device 23 is connected to the predetermined network in a wired or wireless manner, and transmits and receives information to and from other apparatuses such as the computer 10.

The memory/storage 24 is a storage device that stores various types of information. The memory/storage 24 is, for example, a semiconductor memory element such as a random access memory (RAM) or a flash memory or a storage device such as a hard disk or an optical disk. The memory/storage 24 stores various types of information to be used by the processors such as the CPU 21 and the GPU 22 for processing. Additionally, the information resource 30 includes various types of information such as training data. For example, the information resource 30 includes training data to be used for training of various AI models such as LLMs. The AI model 40 includes information of an AI model, such as an LLM, to be used for processing relating to video generation.

Note that as described above, the information processing system 1 may have a configuration other than the configuration illustrated in FIG. 2. For example, the information processing system 1 may have a hardware configuration (also referred to as a “sensor device”) corresponding to the sensor unit 300 in FIG. 1.

The sensor device senses a user's input. The sensor device receives an operation by a user. In addition, for example, the computer 20 may include an IO interface that is an input/output interface device. In this case, the computer 20 receives an input from the sensor device via the IO interface. For example, the computer 20 receives an input from input devices such as a keyboard and a mouse via the IO interface. The computer 20 causes information to be output from a display (display device) and a speaker (audio output device) via the IO interface. For example, the computer 20 plays back a video on the display and through the speaker via the IO interface.

### 1-2. Overview of Processing of Information Processing System

Hereinafter, some examples of processing to be executed by the information processing system 1 will be described. A first processing example and a second processing example will be described below, which are processing examples in which the information processing system 1 receives a comment on a moving image by a user and executes processing (determination processing) of determining a level (comment level) of the received comment. Note that the processing that will be described with the information processing system 1 as a processing entity may be performed by any apparatus capable of executing the processing according to the configuration of apparatuses included in the information processing system 1.

### 1-2-1. First Processing Example

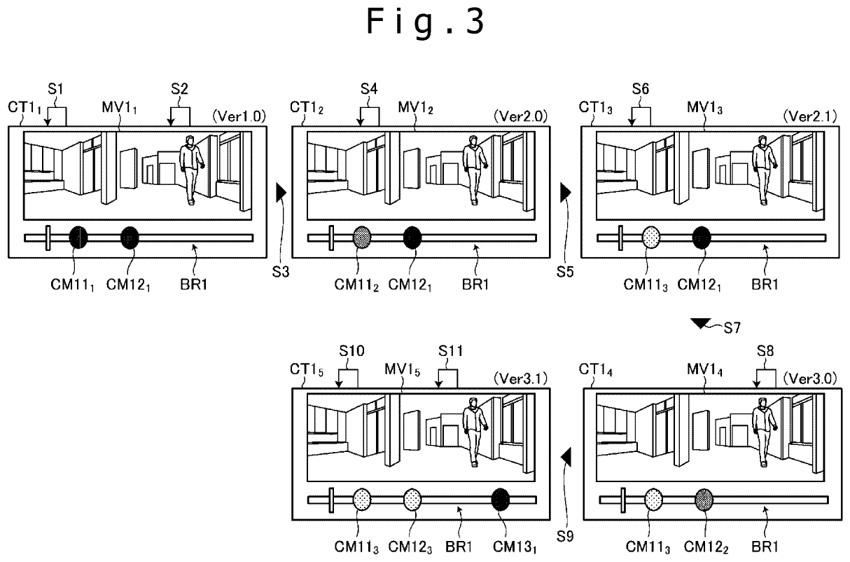

First, an example of processing relating to management of versions and comments to be executed by the information processing system 1 will be described with reference to FIG. 3. FIG. 3 is a diagram illustrating the first processing example to be executed by the information processing system. Note that description of points similar to those described above will be omitted as appropriate.

In the example illustrated in FIG. 3, content CT1 including a moving image MV1, a seek bar BR1, and the like is illustrated as pieces of content CT1₁ to CT1₅ according to the transition of a display mode. Note that the pieces of content CT1₁ to CT1₅ and the like may be referred to as the content CT1 when the display mode and the like are not particularly distinguished in description. For example, in the information processing system 1, the client UI display section 400 displays the content CT1.

A case is illustrated in which a user operates the seek bar BR1 in the content CT1 displayed on the client UI display section 400 and thus the information processing system 1 receives a designation relating to a position (on the timeline) of the moving image MV1 to be displayed. Note that the operation relating to the moving image by using the seek bar is similar to the operation by using a seek bar in the related art, and thus, detailed description thereof will be omitted.

Additionally, the moving image MV1 is illustrated as moving images MV1₁ to MV1₅ according to the versions. Note that the moving images MV1₁ to MV1₅ and the like may be referred to as the moving image MV1 when being described without particularly distinguishing the versions and the like. For example, the moving image MV1₁ to the moving image MV1₅ illustrated in FIG. 1 correspond to the moving image MV1 of the version being displayed on the preview screen at that time.

In the example illustrated in FIG. 3, the user makes three comments on the moving image MV1. A comment icon CM11, which is an icon indicating an initial entry among three comments (hereinafter also referred to as a “first comment”) given to the moving image MV1, is represented as comment icons CM11₁ to CM11₃ according to the levels. Note that the comment icons CM11₁ to CM11₃ and the like may be referred to as the comment icon CM11 when the levels and the like are not particularly distinguished in description.

In addition, a comment icon CM12, which is an icon indicating a second entry among the three comments (hereinafter, also referred to as a “second comment”) given to the moving image MV1, is indicated as comment icons CM12₁ to CM12₃ according to the levels. Note that the comment icons CM12₁ to CM12₃ and the like may be referred to as the comment icon CM12 when the levels and the like are not particularly distinguished in description.

In addition, a comment icon CM13, which is an icon indicating a third entry among the three comments (hereinafter, also referred to as a “third comment”) given to the moving image MV1, is indicated as the comment icon CM13₁ according to the level. Note that the comment icon CM13₁ and the like may be referred to as the comment icon CM13 when the level and the like are not particularly distinguished in description. In addition, when the comment icons CM11, CM12, and the like are not particularly distinguished in description, the comment icons CM11, CM12, and the like may be described as the comment icon CM. Note that, although FIG. 3 illustrates a case where the comment icon CM has an elliptical shape as an example, the shape of the comment icon CM is not limited to the elliptical shape, and may be any shape, and may change according to the comment level.

Hereinafter, details of processing illustrated in FIG. 3 will be described based on the above premise. First, the information processing system 1 displays the content CT1₁ including the moving image MV1₁ and the seek bar BR1. The moving image MV1₁ is the moving image MV1 whose version is 1.0 (or may also be referred to as “Ver1.0”). For example, the moving image MV1₁ is the moving image MV1 before change is made (at the initial stage at the time of generation). Note that in the following description, “VerX.Y” of a version notation such as “Ver1.0” will be described with the portion of “X” (before the dot) as the major version and the portion of “Y” (after the dot) as the minor version.

The information processing system 1 receives a comment (hereinafter, also referred to as a “motion comment”) made by a user with respect to a motion in the moving image MV1₁. In this case, for example, when the user makes the comment, the user selects “motion” as a comment category and inputs the comment. Note that the information processing system 1 may determine a comment category to which a comment corresponds, based on the content of the comment.

In FIG. 3, the information processing system 1 receives a first comment that is a motion comment for a motion at a position (on the timeline) of the moving image MV1 corresponding to a position (on the timeline) at which the comment icon CM11 of the seek bar BR1 is placed. That is, the information processing system 1 receives the first comment (motion comment) input by the user with respect to the motion in Ver1.0 of the moving image MV1.

Then, the information processing system 1 determines a comment level of the first comment (step S1). The information processing system 1 determines the comment level of the first comment based on a version (first version) of the moving image MV1 when the moving image MV1 is displayed and a version (second version) of the moving image MV1 when the first comment is added. For example, the information processing system 1 determines the comment level of the first comment based on the number of modifications of the moving image MV1 corresponding to the comment category “motion” of the first comment between the second version and the first version.

In this case, since both the version of the moving image MV1₁ being displayed in the content CT1₁ (first version) and the version of the moving image MV1 when the first comment is added (second version) are Ver1.0, the information processing system 1 determines the comment level of the first comment to be “0”. That is, since the number of modifications of the moving image MV1 corresponding to the comment category “motion” of the first comment is “0” in a period from the second version (Ver1.0) to the first version (Ver1.0), the information processing system 1 determines the comment level of the first comment to be “0”. Note that the comment level may be determined by various methods other than the above, and other determination examples will be described below.

Then, the information processing system 1 displays information (also referred to as “comment display information”) related to the first comment in a display mode corresponding to the determined comment level. For example, the information processing system 1 displays the comment icon CM11 of the first comment in a display mode corresponding to the determined comment level “0”. The information processing system 1 displays the comment icon CM11₁ of the first comment in a display mode corresponding to the comment level “0” of the first comment. In FIG. 3, the information processing system 1 displays the comment icon CM11₁ of the first comment in the darkest color according to the comment level “0” of the first comment as illustrated in the content CT1₁.

In FIG. 3, changes in display according to the comment levels are represented by the densities of hatching applied to the comment icons CM, and the denser the hatching, the higher the visibility of a user, and the lighter the hatching, the lower the visibility of a user. For example, each comment icon CM is displayed such that the color to be displayed is darker as the hatching is denser, and the color to be displayed is lighter as the hatching is lighter. Note that the color density is merely an example, and the display may be changed according to the comment level by the degree of transparency, the presence or absence of a frame, a display size, the presence or absence of added text, the shape of a comment icon, or the like.

In the example described above, the smaller the value of the comment level of a comment, the higher the degree of importance of the comment. Thus, the information processing system 1 displays the comment display information of the comment such that the visibility of the comment display information of the comment becomes higher as the value of the comment level is smaller. Note that, as long as the comment display information of the comment changes according to the comment level of the comment, the display may be changed according to the comment level based on any criterion other than the visibility of a user. In addition, although a case where the degree of importance of a comment is higher as the value of the comment level of the comment is smaller has been described, any method can be adopted as a method of calculating (determining) the comment level of the comment. For example, the information processing system 1 may calculate (determine) the comment level by using a calculation method (function or the like) in which the degree of importance of the comment increases as the value of the comment level of the comment increases.

The information processing system 1 receives a comment (hereinafter, also referred to as a “camera work comment”) made by the user on camera work in the moving image MV1₁. In FIG. 3, the information processing system 1 receives the second comment, which is the camera work comment on the camera work at a position (on the timeline) of the moving image MV1 corresponding to a position (on the timeline) where the comment icon CM12 of the seek bar BR1 is placed. That is, the information processing system 1 receives the second comment (camera work comment) input by the user on the camera work at Ver1.0 of the moving image MV1.

Then, the information processing system 1 determines the comment level of the second comment (step S2). The information processing system 1 determines the comment level of the second comment based on the version (first version) of the moving image MV1 when the moving image MV1 is displayed and the version (second version) of the moving image MV1 when the second comment is added. Since the number of modifications of the moving image MV1 corresponding to the comment category “camera work” of the second comment is “0” in a period from the second version (Ver1.0) to the first version (Ver1.0), the information processing system 1 determines the comment level of the second comment to be “0”.

Then, the information processing system 1 displays the comment display information of the second comment in a display mode corresponding to the determined comment level. For example, the information processing system 1 displays the comment icon CM12 of the second comment in a display mode corresponding to the determined comment level “0”. The information processing system 1 displays the comment icon CM12₁ of the second comment in a display mode corresponding to the comment level “0” of the second comment. In FIG. 3, the information processing system 1 displays the comment icon CM12₁ of the second comment in the darkest color according to the comment level “0” of the second comment as illustrated in the content CT1₁.

Then, the information processing system 1 changes the motion in the moving image MV1 (step S3). For example, the information processing system 1 receives an editing operation by the user on the motion in the moving image MV1 of Ver1.0 (moving image MV1₁), thereby changing the motion in the moving image MV1 of Ver1.0 (moving image MV1₁). This causes the display mode of the information processing system 1 to transition from the content CT1₁ to the content CT1₂. The moving image MV1₂ in the content CT1₂ is the moving image MV1 whose version is 2.0 (or may also be referred to as “Ver2.0”).

For example, the information processing system 1 receives an editing operation by the user on the moving image MV1 according to an operation by the user on an operation panel or the like for editing the moving image included in the content CT1. In this case, the content CT1 includes an area for displaying an operation panel for editing a moving image. For example, when the user modifies a motion, the information processing system 1 executes processing of searching for the motion according to the operation of the operation panel by the user. Then, the information processing system 1 applies the motion designated by the user to a cast included in the moving image MV1. Note that when a plurality of casts are present, the information processing system 1 receives designation, by the user, of a cast to which the motion is applied.

Further, for example, when the user modifies (changes) a cast, the information processing system 1 selects the cast according to an operation of the operation panel by the user. Then, the information processing system 1 changes the cast included in the moving image MV1 to the cast designated by the user. Note that when a plurality of casts are present, the information processing system 1 receives designation of a cast to be changed by the user. Note that the above is merely an example, and the information processing system 1 may receive an editing operation by the user on a moving image such as the moving image MV1 in any mode as long as the user can perform desired editing.

The information processing system 1 updates the version of the moving image according to the category of the moving image that has been modified (hereinafter referred to as the “modification category”). For example, when a modification related to a different modification category is performed, the information processing system 1 updates the major version that is the highest-order level. For example, when a modification related to a (new) modification category is performed for the first time, the information processing system 1 updates the major version that is the highest-order level. In step S3, since a modification of a first modification category “motion” is performed on the moving image MV1 (moving image MV1₁), the version of the moving image MV1 is updated from Ver1.0 to Ver2.0. Note that the modification category may be explicitly designated (instructed) by the user, or may be automatically determined by the information processing system 1 from a sentence or a designated portion. Further, for example, modification categories are obtained by excluding “entirety” from the comment categories.

Then, the information processing system 1 determines the comment level of each comment according to modifications (step S4). For example, the information processing system 1 determines the comment level of the first comment based on Ver2.0 that is the version (first version) of the moving image MV1 being displayed and Ver1.0 that is the version (second version) of the moving image MV1 when the first comment is added. Since the number of modifications of the moving image MV1 corresponding to the comment category “motion” of the first comment is “1” in a period from the second version (Ver1.0) to the first version (Ver2.0), the information processing system 1 determines the comment level of the first comment to be “1”.

Then, the information processing system 1 displays the comment display information of the first comment in a display mode corresponding to the determined comment level. For example, the information processing system 1 displays the comment icon CM11 of the first comment in a display mode corresponding to the determined comment level “1”. The information processing system 1 displays the comment icon CM11₂ of the first comment in a display mode corresponding to the comment level “1” of the first comment. In FIG. 3, as illustrated in the content CT1₂, the information processing system 1 displays the comment icon CM11₂ of the first comment in a color lighter than the color of the comment icon CM11₁ (a second darkest color or the like) according to the comment level “1” of the first comment.

In addition, since the number of modifications of the moving image MV1 corresponding to the comment category “camera work” of the second comment is “0” in a period from the second version (Ver1.0) to the first version (Ver2.0), the information processing system 1 determines the comment level of the second comment to be “0”. In this case, since no change occurs in the comment level of the second comment, the information processing system 1 continues to display the comment icon CM12₁ in a case of the comment icon CM12.

Then, the information processing system 1 changes the motion in the moving image MV1 (step S5). For example, the information processing system 1 receives an editing operation by the user on the motion in the moving image MV1 of Ver2.0 (moving image MV1₂), thereby changing the motion in the moving image MV1 of Ver2.0 (moving image MV1₂). This causes the display mode of the information processing system 1 to transition from the content CT1₂ to the content CT13. The moving image MV13 in the content CT13 is the moving image MV1 whose version is 2.1 (or may also be referred to as “Ver2.1”).

As described above, the information processing system 1 updates the version of the moving image according to the modification category. For example, when a modification related to the same modification category as the modification category of the immediately preceding modification is performed, the information processing system 1 updates a minor version that is a lower-order level relative to the major version. In step S5, since the moving image MV1 (moving image MV1₂) is modified regarding the same modification category “motion” as that of the immediately preceding modification, the version of the moving image MV1 is updated from Ver2.0 to Ver2.1. In this manner, when a modification related to the same modification category as the modification category of the immediately preceding modification is performed, the information processing system 1 adds 1 to the minor version.

Then, the information processing system 1 determines the comment level of each comment according to the modifications (step S6). For example, the information processing system 1 determines the comment level of the first comment based on Ver2.1 that is a version (first version) of the moving image MV1 being displayed and Ver1.0 that is a version (second version) of the moving image MV1 when the first comment is added. Since the number of modifications of the moving image MV1 corresponding to the comment category “motion” of the first comment is “2” in a period from the second version (Ver1.0) to the first version (Ver2.1), the information processing system 1 determines the comment level of the first comment to be “2”.

Then, the information processing system 1 displays the comment display information of the first comment in a display mode corresponding to the determined comment level. For example, the information processing system 1 displays the comment icon CM11 of the first comment in a display mode corresponding to the determined comment level “2”. The information processing system 1 displays the comment icon CM11₃ of the first comment in a display mode corresponding to the comment level “2” of the first comment. In FIG. 3, as illustrated in the content CT13, the information processing system 1 displays the comment icon CM11₃ of the first comment in a color (third darkest color, or the like) lighter than that of the comment icon CM11₂ according to the comment level “2” of the first comment.

In addition, since the number of modifications of the moving image MV1 corresponding to the comment category “camera work” of the second comment is “0” in a period from the second version (Ver1.0) to the first version (Ver2.1), the information processing system 1 determines the comment level of the second comment to be “0”. In this case, since no change occurs in the comment level of the second comment, the information processing system 1 continues to display the comment icon CM12₁ in a case of the comment icon CM12.

Then, the information processing system 1 changes the camera work in the moving image MV1 (step S7). For example, the information processing system 1 changes the camera work in the moving image MV1 of Ver2.1 (moving image MV1₃) by receiving an editing operation by the user on the camera work in the moving image MV1 of Ver2.1 (moving image MV1₃). This causes the display mode of the information processing system 1 to transition from the content CT1₃ to the content CT1₄. The moving image MV1₄ in the content CT1₄ is the moving image MV1 whose version is 3.0 (or may also be referred to as “Ver3.0”).

For example, when the user modifies the camera work, the information processing system 1 executes processing of changing a shot size or the like according to an operation of the operation panel by the user. Then, when the user performs an operation of applying a change, such as pressing an apply button, the information processing system 1 applies the changed camera work to the moving image MV1. Note that in the information processing system 1, the user may repeatedly change (modify) the camera work or the like until a desired state is obtained.

The information processing system 1 updates the version of the moving image according to the modification category. In step S7, since the moving image MV1 (moving image MV1₃) has been modified regarding the modification category “camera work” different from the modification category “motion” of the immediately preceding modification, the version of the moving image MV1 is updated from Ver2.1 to Ver3.0. In this manner, when a modification related to a modification category different from the modification category of the immediately preceding modification is performed, the information processing system 1 adds 1 to the major version.

Then, the information processing system 1 determines the comment level of each comment according to the modifications (step S8). For example, since the number of modifications of the moving image MV1 corresponding to the comment category “motion” of the first comment is “2” in a period from the second version (Ver1.0) to the first version (Ver3.0), the information processing system 1 determines the comment level of the first comment to be “2”. In this case, since the comment level of the first comment is not changed, the information processing system 1 continues to display the comment icon CM11₃ for the comment icon CM11.

In addition, since the number of modifications of the moving image MV1 corresponding to the comment category “camera work” of the second comment is “1” in a period from the second version (Ver1.0) to the first version (Ver3.0), the information processing system 1 determines the comment level of the second comment to be “1”. Then, the information processing system 1 displays the comment display information of the second comment in a display mode corresponding to the determined comment level. For example, the information processing system 1 displays the comment icon CM12 of the second comment in a display mode corresponding to the determined comment level “1”. The information processing system 1 displays the comment icon CM12₂ of the second comment in a display mode corresponding to the comment level “1” of the second comment. In FIG. 3, the information processing system 1 displays the comment icon CM12₂ of the second comment in a color (second darkest color or the like) lighter than that of the comment icon CM12₁ according to the comment level “1” of the second comment as illustrated in the content CT1₄.

Then, the information processing system 1 changes the camera work in the moving image MV1 (step S9). For example, the information processing system 1 receives an editing operation by the user on the camera work in the moving image MV1 of Ver3.0 (moving image MV1₄), and thus changes the camera work in the moving image MV1 of Ver3.0 (moving image MV1₄). This causes the display mode of the information processing system 1 to transition from the content CT1₄ to the content CT1₅. The moving image MV1₅ in the content CT1₅ is the moving image MV1 whose version is 3.1 (or may also be referred to as “Ver3.1”).

The information processing system 1 updates the version of the moving image according to the modification category. In step S9, since the modification of the same modification category “camera work” as that of the immediately preceding modification is performed on the moving image MV1 (moving image MV1₄) in step S9, the version of the moving image MV1 is updated from Ver3.0 to Ver3.1.

Then, the information processing system 1 determines the comment level of each comment according to the modifications (step S10). For example, the number of modifications of the moving image MV1 corresponding to the comment category “motion” of the first comment is “2” in a period from the second version (Ver1.0) to the first version (Ver3.1), and thus, the information processing system 1 determines the comment level of the first comment to be “2”. In this case, since the comment level of the first comment is not changed, the information processing system 1 continues to display the comment icon CM11₃ for the comment icon CM11.

In addition, since the number of modifications of the moving image MV1 corresponding to the comment category “camera work” of the second comment is “2” in a period from the second version (Ver1.0) to the first version (Ver3.1), the information processing system 1 determines the comment level of the second comment to be “2”. Then, the information processing system 1 displays the comment display information of the second comment in a display mode corresponding to the determined comment level. For example, the information processing system 1 displays the comment icon CM12 of the second comment in a display mode corresponding to the determined comment level “2”. The information processing system 1 displays the comment icon CM12₃ of the second comment in a display mode corresponding to the comment level “2” of the second comment. In FIG. 3, as illustrated in the content CT1₅, the information processing system 1 displays the comment icon CM12₃ of the second comment in a color (third darkest color or the like) lighter than the color of the comment icon CM12₂ according to the comment level “2” of the second comment.

In addition, the information processing system 1 receives a comment (camera work comment) made by the user on the camera work in the moving image MV1₅. In FIG. 3, the information processing system 1 receives a third comment that is a camera work comment for the camera work at a position (on the timeline) of the moving image MV1 corresponding to a position (on the timeline) at which the comment icon CM13 of the seek bar BR1 is placed. That is, the information processing system 1 receives the third comment (camera work comment) input by the user on the camera work in the moving image MV1 of Ver3.1.

Then, the information processing system 1 determines a comment level of the third comment (step S11). The information processing system 1 determines the comment level of the third comment based on the version (first version) of the moving image MV1 when the moving image MV1 is displayed and the version (second version) of the moving image MV1 when the third comment is added. Since the number of modifications of the moving image MV1 corresponding to the comment category “camera work” of the third comment is “0” in a period from the second version (Ver3.1) to the first version (Ver3.1), the information processing system 1 determines the comment level of the third comment to be “0”.

Then, the information processing system 1 displays the comment display information of the third comment in a display mode corresponding to the determined comment level. For example, the information processing system 1 displays the comment icon CM13 of the third comment in a display mode corresponding to the determined comment level “0”. The information processing system 1 displays the comment icon CM13₁ of the third comment in a display mode corresponding to the comment level “0” of the third comment. In FIG. 3, the information processing system 1 displays the comment icon CM13₁ of the third comment in the darkest color according to the comment level “0” of the third comment as illustrated in the content CT1₁. By the above-described processing, the information processing system 1 can appropriately manage comments on moving images.

### 1-2-2. Second Processing Example

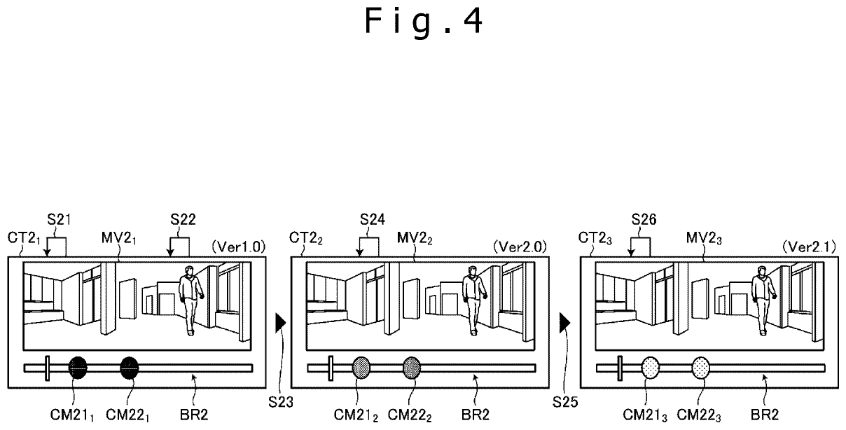

Here, the information processing system 1 may perform various types of processing other than the first processing example described above, and the information processing system 1 may use a category not included in the modification categories as a comment category. For example, the information processing system 1 may use the category “entirety”, which is not included in the modification categories, as the comment category. An example in this case will be described with reference to FIG. 4. FIG. 4 is a diagram illustrating a second processing example to be executed by the information processing system. Note that description of points similar to those described above will be omitted as appropriate.

In the example illustrated in FIG. 4, content CT2 including a moving image MV2, a seek bar BR2, and the like is illustrated as content CT2₁ to CT2₃ according to the transition of the display mode. Note that the content CT2₁ to the content CT2₃ and the like may be referred to as the content CT2 when the display mode and the like are not particularly distinguished. For example, in the information processing system 1, the client UI display section 400 displays the content CT2.

In addition, the moving image MV2 is illustrated as moving images MV2₁ to MV2₃ according to versions. Note that the moving images MV2₁ to MV2₃ and the like may be referred to as the moving image MV2 when the versions and the like are not particularly distinguished in description.

In the example illustrated in FIG. 4, the user makes two comments on the moving image MV2. The comment icon CM21, which is an icon indicating one comment (hereinafter also referred to as a “first comment”) of the two comments given to the moving image MV2, will be denoted as comment icons CM21₁ to CM21₃ according to the levels thereof. Note that the comment icons CM21₁ to CM21₃ and the like may be referred to as the comment icon CM21 when the levels and the like are not particularly distinguished in description.

In addition, the comment icon CM22, which is an icon indicating the other comment (hereinafter, also referred to as a “second comment”) of the two comments given to the moving image MV2, is indicated as comment icons CM22₁ to CM22₃ according to the levels thereof. Note that the comment icons CM22₁ to CM22₃ and the like may be referred to as the comment icon CM22 when the levels and the like are not particularly distinguished in description.

The processing illustrated in FIG. 4 will be described below in details based on the above premise. First, the information processing system 1 displays the content CT2₁ including the moving image MV2₁ and the seek bar BR2. The moving image MV2₁ is the moving image MV2 whose version is 1.0 (or may also be referred to as “Ver1.0”). For example, the moving image MV2₁ is the moving image MV2 before change is made (at an initial stage at the time of generation). In the following description, “VerX.Y” of a version notation such as “Ver1.0” will be described with the portion of “X” (before the dot) as the major version and the portion of “Y” (after the dot) as the minor version.

The information processing system 1 receives a comment (hereinafter, also referred to as a “motion comment”) made by the user on the motion in the moving image MV2₁. In this case, for example, when the user makes the comment, the user selects “motion” as a comment category and inputs the comment. Note that the information processing system 1 may determine a comment category to which a comment corresponds, based on the content of the comment.

In FIG. 4, the information processing system 1 receives a first comment that is a motion comment on a motion at a position (on the timeline) of the moving image MV2 corresponding to a position (on the timeline) at which the comment icon CM21 of the seek bar BR2 is placed. That is, the information processing system 1 receives the first comment (motion comment) input by the user on the motion in the moving image MV2 of Ver1.0.

Then, the information processing system 1 determines the comment level of the first comment (step S21). The information processing system 1 determines the comment level of the first comment based on the version (first version) of the moving image MV2 when the moving image MV2 is displayed and the version (second version) of the moving image MV2 when the first comment is added. For example, the information processing system 1 determines the comment level of the first comment based on the number of modifications of the moving image MV2 corresponding to the comment category “motion” of the first comment between the second version and the first version.

In this case, since both the version of the moving image MV2₁ being displayed in the content CT2₁ (first version) and the version of the moving image MV2 when the first comment is added (second version) are Ver1.0, the information processing system 1 determines the comment level of the first comment to be “0”. That is, since the number of modifications of the moving image MV2 corresponding to the comment category “motion” of the first comment is “0” in a period from the second version (Ver1.0) to the first version (Ver1.0), the information processing system 1 determines the comment level of the first comment to be “0”.

Then, the information processing system 1 displays information (comment display information) related to the first comment in a display mode corresponding to the determined comment level. For example, the information processing system 1 displays the comment icon CM21 of the first comment in a display mode corresponding to the determined comment level “0”. The information processing system 1 displays the comment icon CM21₁ of the first comment in a display mode corresponding to the comment level “0” of the first comment. In FIG. 4, the information processing system 1 displays the comment icon CM21₁ of the first comment in the darkest color according to the comment level “0” of the first comment as illustrated in the content CT2₁.

The information processing system 1 receives a comment (hereinafter, also referred to as “entire comment”) made by the user on the entire moving image MV2₁. In FIG. 4, the information processing system 1 receives a second comment that is an entire comment on the entire moving image MV2 at the position (on the timeline) corresponding to a position (on the timeline) at which the comment icon CM22 of the seek bar BR2 is placed. That is, the information processing system 1 receives the second comment (entire comment) input by the user on the entire moving image MV2 of Ver1.0.

Then, the information processing system 1 determines a comment level of the second comment (step S22). The information processing system 1 determines the comment level of the second comment based on the version (first version) of the moving image MV2 when the moving image MV2 is displayed and the version (second version) of the moving image MV2 when the second comment is added. Since the number of modifications of the moving image MV2 corresponding to the comment category “entirety” of the second comment is “0” in a period from the second version (Ver1.0) to the first version (Ver1.0), the information processing system 1 determines a comment level of the second comment to be “0”.

Note that, for example, all the modification categories correspond to the comment category “entirety”. The information processing system 1 stores category correspondence information including correspondence between the comment category “entirety” and the modification category in the storage unit. The category correspondence information includes information indicating correspondence between other comment categories and modification categories. In this case, the information processing system 1 calculates the number of modifications corresponding to the comment using the category correspondence information. For example, the information processing system 1 calculates the number of modifications corresponding to the comment category “entirety”, assuming that the modification of any modification category is a modification corresponding to the comment category “entirety”. Note that the modification category may be associated with the comment category “entirety” in any manner. One or some of the modification categories may be associated with the comment category “entirety”.

Then, the information processing system 1 displays the comment display information of the second comment in a display mode corresponding to the determined comment level. For example, the information processing system 1 displays the comment icon CM22 of the second comment in a display mode corresponding to the determined comment level “0”. The information processing system 1 displays the comment icon CM22₁ of the second comment in a display mode corresponding to the comment level “0” of the second comment. In FIG. 4, the information processing system 1 displays the comment icon CM22₁ of the second comment in the darkest color according to the comment level “0” of the second comment as illustrated in the content CT2₁.

Then, the information processing system 1 changes the motion in the moving image MV2 (step S23). For example, the information processing system 1 receives an editing operation of the user on the motion in the moving image MV2 of Ver1.0 (moving image MV2₁), thereby changing the motion in the moving image MV2 of Ver1.0 (moving image MV2₁). This causes the display mode of the information processing system 1 to transition from the content CT2₁ to the content CT2₂. The moving image MV2₂ in the content CT2₂ is the moving image MV2 of Ver2.0.

The information processing system 1 updates the version of the moving image according to the category (modification category) in which the moving image is modified. In step S23, since the modification of the modification category “motion” is first performed on the moving image MV2 (moving image MV2₁), the version of the moving image MV2 is updated from Ver1.0 to Ver2.0.

Then, the information processing system 1 determines the comment level of each comment according to the modifications (step S24). For example, the information processing system 1 determines the comment level of the first comment based on Ver2.0 that is the version (first version) of the moving image MV2 being displayed and Ver1.0 that is the version (second version) of the moving image MV2 when the first comment is added. Since the number of modifications of the moving image MV2 corresponding to the comment category “motion” of the first comment is “1” in a period from the second version (Ver1.0) to the first version (Ver2.0), the information processing system 1 determines the comment level of the first comment as “1”.

Then, the information processing system 1 displays the comment display information of the first comment in a display mode corresponding to the determined comment level. For example, the information processing system 1 displays the comment icon CM21 of the first comment in a display mode corresponding to the determined comment level “1”. The information processing system 1 displays the comment icon CM212 of the first comment in a display mode corresponding to the comment level “1” of the first comment. In FIG. 4, as illustrated in the content CT2₂, the information processing system 1 displays the comment icon CM21₂ of the first comment in a color (the second darkest color or the like) lighter than the color of the comment icon CM21₁ according to the comment level “1” of the first comment.

In addition, since the number of modifications of the moving image MV2 corresponding to the comment category “entirety” of the second comment is “1” in a period from the second version (Ver1.0) to the first version (Ver2.0), the information processing system 1 determines the comment level of the second comment to be “1”.

Then, the information processing system 1 displays the comment display information of the second comment in a display mode corresponding to the determined comment level. For example, the information processing system 1 displays the comment icon CM22 of the second comment in a display mode corresponding to the determined comment level “1”. The information processing system 1 displays the comment icon CM22₂ of the second comment in a display mode corresponding to the comment level “1” of the second comment. In FIG. 4, as illustrated in the content CT2₂, the information processing system 1 displays the comment icon CM22₂ of the second comment in a color (the second darkest color or the like) lighter than the color of the comment icon CM22₁ according to the comment level “1” of the second comment.

Then, the information processing system 1 changes the motion in the moving image MV2 (step S25). For example, the information processing system 1 receives an editing operation of the user on the motion in the moving image MV2 of Ver2.0 (moving image MV2₂), thereby changing the motion in the moving image MV2 of Ver2.0 (moving image MV2₂). This causes the display mode of the information processing system 1 to transition from the content CT2₂ to the content CT2₃. The moving image MV2₃ in the content CT2₃ is the moving image MV2 of Ver2.1.

The information processing system 1 updates the version of the moving image according to the modification category. In step S25, since the moving image MV2 (moving image MV2₂) is modified in the same modification category “motion” as that of the immediately preceding modification, the version of the moving image MV2 is updated from Ver2.0 to Ver2.1.

Then, the information processing system 1 determines the comment level of each comment according to the modifications (step S26). For example, the information processing system 1 determines the comment level of the first comment based on Ver2.1 that is the version (first version) of the moving image MV2 being displayed and Ver1.0 that is the version (second version) of the moving image MV2 when the first comment is added. Since the number of modifications of the moving image MV2 corresponding to the comment category “motion” of the first comment is “2” in a period from the second version (Ver1.0) to the first version (Ver2.1), the information processing system 1 determines the comment level of the first comment to be “2”.

Then, the information processing system 1 displays the comment display information of the first comment in a display mode corresponding to the determined comment level. For example, the information processing system 1 displays the comment icon CM21 of the first comment in a display mode corresponding to the determined comment level “2”. The information processing system 1 displays the comment icon CM21₃ of the first comment in a display mode corresponding to the comment level “2” of the first comment. In FIG. 4, as illustrated in the content CT2₃, the information processing system 1 displays the comment icon CM21₃ of the first comment in a color (third darkest color, or the like) lighter than the color of the comment icon CM21₂ according to the comment level “2” of the first comment.

In addition, since the number of modifications of the moving image MV2 corresponding to the comment category “entirety” of the second comment is “2” in a period from the second version (Ver1.0) to the first version (Ver2.1), the information processing system 1 determines the comment level of the second comment to be “2”.

Then, the information processing system 1 displays the comment display information of the second comment in a display mode corresponding to the determined comment level. For example, the information processing system 1 displays the comment icon CM22 of the second comment in a display mode corresponding to the determined comment level “2”. The information processing system 1 displays the comment icon CM22₃ of the second comment in a display mode corresponding to the comment level “2” of the second comment. In FIG. 4, as illustrated in the content CT2₃, the information processing system 1 displays the comment icon CM22₃ of the second comment in a color (third darkest color, or the like) lighter than the color of the comment icon CM22₂ according to the comment level “2” of the second comment. By the above-described processing, the information processing system 1 can appropriately manage comments on moving images.

For example, when a moving image is modified by editing or the like in video (moving image) generation, the version of the moving image is updated, and the number of versions increases as the more minor modification is made. In addition, when a user can input a comment for each version, or the like, it may be difficult for a user to recognize the importance or the like of each comment. In this manner, in the moving image generation, the number of versions increases according to editing (modification). In addition, in the moving image generation, when the version is changed, it may be difficult to determine whether or not the comment is left for the version, and in a case where the comment is left, the comment to be highlighted as important for the user may be buried.

Thus, as illustrated in FIG. 1 and FIG. 2, the information processing system 1 updates the version of the moving image including the major version and the minor version according to the modification of the moving image. For example, the information processing system 1 updates the minor version by treating a modification of the same category as that of the immediately preceding modification as a minor version modification. In addition, a modification of a category different from that of the immediately preceding modification is regarded as a major version modification, and the major version is updated.

In addition, the information processing system 1 determines the comment level of the comment added to the moving image according to the version and the modification of the moving image, and changes the display according to the determined comment level. For example, the information processing system 1 determines a comment level based on the comment category and the display version, and changes the display according to the comment level.

In this manner, the information processing system 1 can appropriately determine a comment level of a comment added to a moving image based on a category of the comment, a version of the moving image to which the comment is added, the version of a moving image being displayed, and the like. This allows the information processing system 1 to provide appropriate information to the user by changing the display of the comment or the like according to the comment level indicating the degree of importance or the like of the comment. Thus, the information processing system 1 can appropriately manage comments on moving images. For example, in the information processing system 1, even when the version of the moving image is changed, the comment level is determined (set) according to the amount of change or the like, and thus, it is possible to allow the user to recognize (understand) the degree of change at a glance.

Note that in the information processing system 1, as described above, the comment can be given to the moving image for each comment category such as the entirety, the motion, or the background. In addition, in the above-described example, a case where a user who is a person (natural person) makes a comment on a moving image has been described as an example, but a subject who makes a comment is not limited to a person, and may be a computer, software, or the like included in the information processing system 1. For example, a subject who makes a comment on a moving image may be an AI creator generated by an AI technology.

The AI creator referred to here is a fictitious creator to which a predetermined personality is given. For example, the AI creator may be a fictitious creator to which a personality imitating an actual person is given, or may be a fictitious creator to which a personality is given based on predetermined settings that do not imitate an actual person.

For example, the personality of the AI creator is given by adding information (personality information) corresponding to the personality of the AI creator to a prompt to be input to the AI model. Note that the personality assignment to the AI creator is not limited to the mode of adding the personality information to the prompt, and any mode can be adopted as long as a desired personality can be given. For example, by using an AI model corresponding to each AI creator, the personality of the AI creator may be given.

When the AI creator is applied as described above, in the information processing system 1, a user who is a person (natural person) may perform work of generating a moving image in cooperation with the AI creator. Then, in the information processing system 1, similarly to the comment given to the moving image by the user who is a person (natural person), the comment level of a comment given to the moving image by the AI creator is determined (calculated), and the display of the comment or the like is changed according to the determined comment level. This allows the information processing system 1 to provide appropriate information to the user, even when the user who is a person (natural person) performs the work of generating a moving image in cooperation with the AI creator.

In addition to the above-described processing, the information processing system 1 may provide various services related to moving image generation to a user. For example, when a user selects a comment, the information processing system 1 may provide information according to the comment selected by the user. In this case, the information processing system 1 may change the display according to the version when the comment selected by the user is added. For example, when the user selects (clicks or the like) a comment, the information processing system 1 may change the moving image MV1 being displayed on the preview screen to the moving image MV1 of the version when the comment is added.

### 1-3. Overview of Processing of Information Processing System

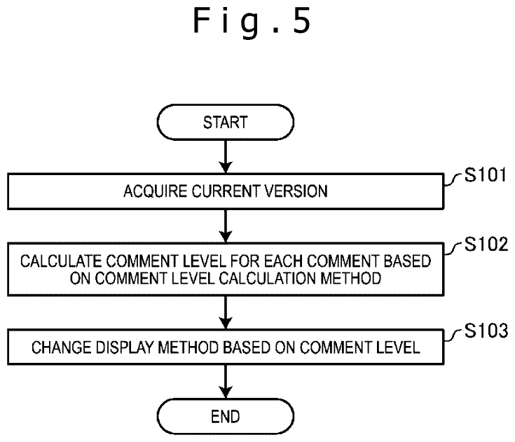

Hereinafter, an example of a procedure of information processing to be executed by the information processing system 1 will be described. First, an example of the procedure of the information processing illustrated in FIG. 5 will be described. FIG. 5 is a flowchart illustrating the processing procedure to be executed by the information processing system. For example, FIG. 5 is a flowchart illustrating a procedure related to comment management processing to be executed by the information processing system 1.

The information processing system 1 acquires a current version (step S101). For example, the information processing system 1 acquires the version of a moving image being displayed.

Then, the information processing system 1 calculates the comment level of each comment based on a comment level calculation method (step S102). For example, the information processing system 1 calculates the comment level of each comment according to modifications between the version of the moving image being displayed and the version of the moving image to which the comment is added.

Then, the information processing system 1 changes the display method based on the comment level (step S103). For example, the information processing system 1 outputs comment display information whose display is changed according to the comment level.

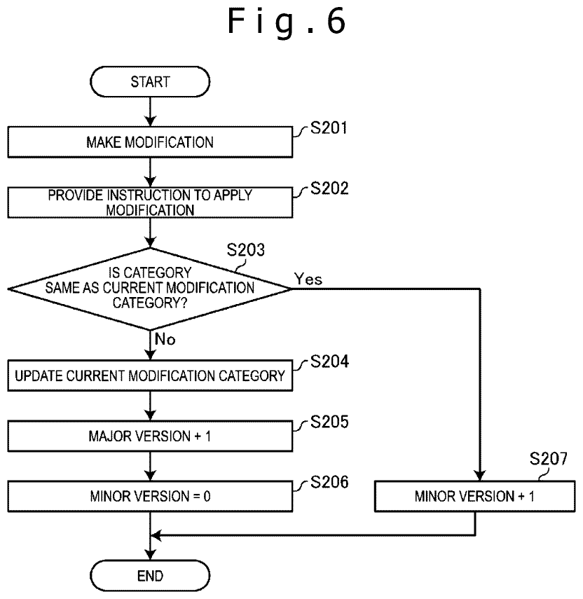

Next, an example of a procedure of information processing illustrated in FIG. 6 will be described. FIG. 6 is a flowchart illustrating a procedure related to version update processing to be executed by the information processing system. For example, FIG. 6 is a flowchart illustrating a procedure related to version management processing to be executed by the information processing system 1.

The information processing system 1 receives a modification (step S201). For example, the information processing system 1 receives an edit (modification) of a moving image by a user. Then, the information processing system 1 receives an instruction for applying the modification (step S202). For example, the information processing system 1 receives an instruction for applying an edit (modification) of a moving image by a user. Note that, when the received modification is applied without the instruction for applying the modification, the information processing system 1 does not necessarily perform the processing of step S202.

When the modification is not the same as the current modification category (step S203: No), the information processing system 1 updates the current modification category (step S204). For example, when the modification category of the modification performed in step 201 is different from the modification category (current modification category) of the immediately preceding modification, the information processing system 1 updates the current modification category to the modification category of the modification performed in step 201.

Then, the information processing system 1 adds 1 to the major version (step S205). For example, the information processing system 1 adds 1 to the major version of the version of the moving image. The information processing system 1 updates the minor version to 0 (step S206). For example, the information processing system 1 updates (initializes) the minor version of the version of the moving image to 0.

Further, when the modification is made the same as the current modification category (step S203: Yes), the information processing system 1 adds 1 to the minor version (step S207). For example, when the modification made in step 201 is a modification of the same modification category as that of the immediately preceding modification, the information processing system 1 adds 1 to the minor version of the version of the moving image.

### 1-4. Processing Example

Hereinafter, various types of processing to be executed by the information processing system 1 will be described based on the above premise. Note that description of points similar to those described above will be omitted as appropriate.

### 1-4-1. Comment Categories and Processing Example

For example, the information processing system 1 may perform determination processing of a comment level according to a configuration of the comment categories. Some examples of this point will be described below. Note that description of points similar to those described above will be omitted as appropriate.

### 1-4-1-1. First Configuration Example of Comment Categories

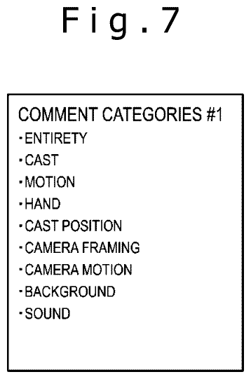

First, a first configuration example of comment categories illustrated in FIG. 7 will be described. FIG. 7 is a diagram illustrating the first configuration example of the comment categories. “Comment categories #1” in FIG. 7 indicate the first configuration example of the comment categories. In the first configuration example of the comment categories in FIG. 7, a case where the entirety, cast, motion, hand, cast position, camera framing, camera motion, background, sound, and the like are included in the comment categories is illustrated. As illustrated in the first configuration example of the comment categories in FIG. 7, the comment categories do not necessarily have a hierarchical relationship between the comment categories, and all the comment categories may be at the same level.

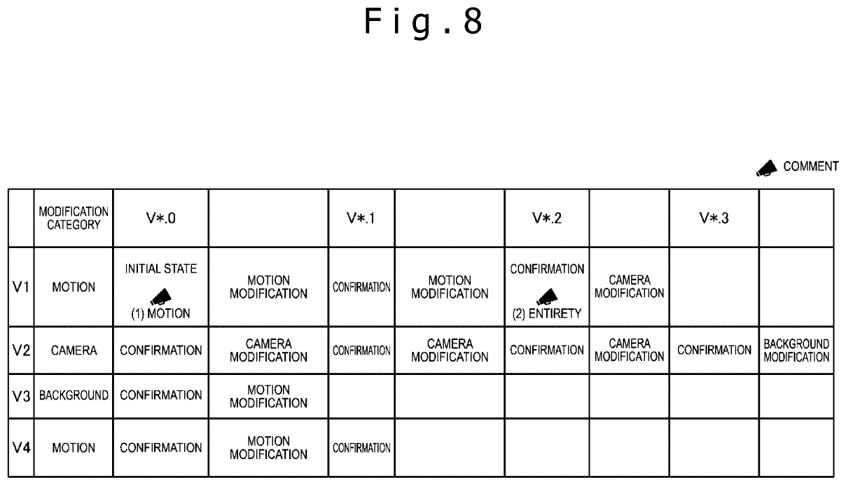

An example of the determination processing of the comment level in the first configuration example of the comment categories in FIG. 7 will be described with reference to FIG. 8. FIG. 8 is a diagram illustrating an example of determining a comment level.

FIG. 8 illustrates relationships among comments on a moving image, modifications to the moving image, and versions of the moving image in a matrix diagram. Each row of the matrix diagram in FIG. 8 corresponds to a major version, and Ver1, Ver2, Ver3, and Ver4 are arranged from top to bottom in this order. Among the columns of the matrix diagram in FIG. 8, the column labeled “Modification Category” indicates the modification categories corresponding to the major version.

In addition, “V*.0”, “V*.1”, “V*.2”, “V*.3”, and the like in the columns of the matrix diagram in FIG. 8 correspond to the minor versions. Further, among the columns of the matrix diagram in FIG. 8, each of the columns denoted by “V*.0”, “V*.1”, “V*.2”, and “V. 3” indicates the state of the corresponding version, the behavior (check, comment) of the user in the version, and the like. In addition, among the columns of the matrix diagram in FIG. 8, each of the columns on the right side of “V*.0”, “V*.1”, “V*.2”, “V*.3”, and the like indicates a modification performed on the version corresponding to the column on the left side of each column.

In FIG. 8, the information processing system 1 receives a comment of the comment category “motion” for a moving image of Ver1.0 as indicated in “(1) motion”. Further, the information processing system 1 receives a modification of the modification category “motion” to the moving image of Ver1.0, and updates the version of the moving image to V1.1.

In addition, the information processing system 1 receives a modification of the modification category “motion” to the moving image of Ver1.1, and updates the version of the moving image to V1.2. Furthermore, as indicated by “(2) entirety”, the information processing system 1 receives a comment of the comment category “entirety” on the moving image of Ver1.2.

Further, the information processing system 1 receives a modification of the modification category “camera” to the moving image of Ver1.2, and updates the version of the moving image to Ver2.0. Furthermore, the information processing system 1 receives a modification of the modification category “background” to the moving image of Ver2.3, and updates the version of the moving image to Ver3.0.

Additionally, the information processing system 1 receives a modification of the modification category “motion” to the moving image of Ver3.0, and updates the version of the moving image to Ver4.0. In addition, the information processing system 1 receives a modification of the modification category “motion” to the moving image of Ver4.0, and updates the version of the moving image to Ver4.1.

Hereinafter, a method of calculating the comment level of each of (1) motion and (2) entirety in FIG. 8 will be described. The information processing system 1 may calculate the number of modifications corresponding to the category and determine the number of modifications as the comment level of the comment. Hereinafter, this calculation method is also referred to as a “first calculation method”.

For example, in the first calculation method, the total number of modifications of each category before the first version, which is the current version or the like, is calculated as the comment level. For example, in the first calculation method, the information processing system 1 calculates the comment level by using the following Equation (1). Note that the “current version” in Equation (1) may be read as the “first version”. For example, the current version in Equation (1) is the version of the moving image being displayed.

$$\begin{matrix}[ Math . 1 ] & \\ Comment level = total number of modifications of each category before current version & ( 1 )\end{matrix}$$

For example, the information processing system 1 calculates the comment level of (1) motion by the first calculation method. When the first version is “4.1”, the information processing system 1 calculates the comment level of (1) motion as “4”. In addition, when the first version is “3.0”, the information processing system 1 calculates the comment level of (1) motion as “2”.

Further, for example, the information processing system 1 calculates each comment level of (2) entirety by the first calculation method. When the first version is “4.1”, the information processing system 1 calculates the comment level of (2) entirety as “7”. In addition, when the first version is “3.0”, the information processing system 1 calculates the comment level of (2) entirety as “5”.

The information processing system 1 may also determine the comment level by using a calculation value calculated based on a weight corresponding to a difference between a version (third version) in which a modification corresponding to a category is made and the first version, and the number of modifications corresponding to the category in the third version. Hereinafter, this calculation method is also referred to as a “second calculation method”.

For example, in the second calculation method, the information processing system 1 calculates the comment level by using the following Equation (2). Note that the “current version” in Equation (2) may be read as the “first version”. For example, the current version in Equation (2) is the version of the moving image being displayed. In addition, in a case of the same version, the information processing system 1 calculates the comment level by setting the value (0) of a “difference between each version and the current version” in Equation (2) to “½”.

$$\begin{matrix}[ Math . 2 ] & \\ Comment level = \sum ( ( total number of modifications of each category in each version before current version ) * ( 1 / ( difference between each version and current version ) ) & ( 2 )\end{matrix}$$

For example, the information processing system 1 calculates the comment level of (1) motion by the second calculation method. When the first version is “4.1”, the information processing system 1 calculates the comment level of (1) motion as “3.67” (=1*2+1*1/1+2*⅓). In addition, when the first version is “3.0”, the information processing system 1 calculates the comment level of (1) motion as “1” (=2*½).

Further, for example, the information processing system 1 calculates each comment level of (2) entirety by the second calculation method. When the first version is “4.1”, the information processing system 1 calculates the comment level of (2) entirety as “5.33” (=1*2+1*1/1+4*½+1*⅓). In addition, when the first version is “3.0”, the information processing system 1 calculates the comment level of (2) entirety as “4.5” (=4*1/1+1*½).

### 1-4-1-2. Second Configuration Example of Comment Categories

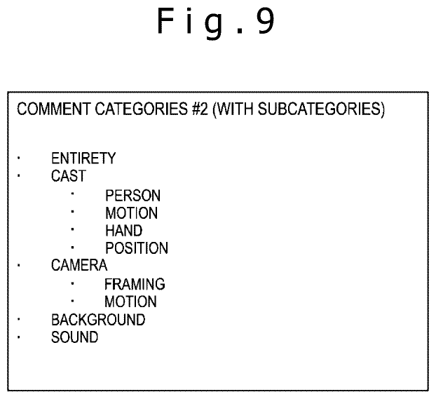

Next, a second configuration example of the comment categories illustrated in FIG. 9 will be described. FIG. 9 is a diagram illustrating the second configuration example of the comment categories. In FIG. 9, “comment categories #2 (with subcategories)” indicate the second configuration example of the comment categories. The second configuration example of the comment categories in FIG. 9 illustrates a case where the entirety, cast, person, motion, hand, position, camera, framing, motion, background, sound, and the like are included in the comment categories. As illustrated in the second configuration example of the comment categories in FIG. 9, the comment categories are hierarchically structured according to the concepts of the comment categories. In the second configuration example of the comment categories in FIG. 9, the entirety, cast, camera, background, sound, and the like are at the highest level. In addition, the person, motion, hand, and position are at a lower level of the cast. Additionally, the framing and motion are at a lower level of the camera.

Note that the second configuration example of the comment categories in FIG. 9 is merely an example of a configuration when the comment categories are hierarchically structured according to the concepts of the comment categories, and the hierarchical structure of the comment categories is not limited to the hierarchical structure illustrated in the second configuration example, and any hierarchical structure can be adopted. Modification categories may be also hierarchically structured similarly to the comment categories. In this case, the configuration of the hierarchically structured modification categories may be obtained by excluding the entirety from the configuration example illustrated in FIG. 9.

In this case, the information processing system 1 may update the version in a case of the modification of the modification category being at the lower level of the highest level, as the modification common to that of the modification category at the highest level. For example, the information processing system 1 may add 1 to the major version when the modification of the modification category belonging to the highest level different from that at the highest level to which the modification category of the immediately preceding modification belongs is made, and may add 1 to the minor version when the modification of the modification category being at the highest level to which the modification category of the immediately preceding modification belongs is made.

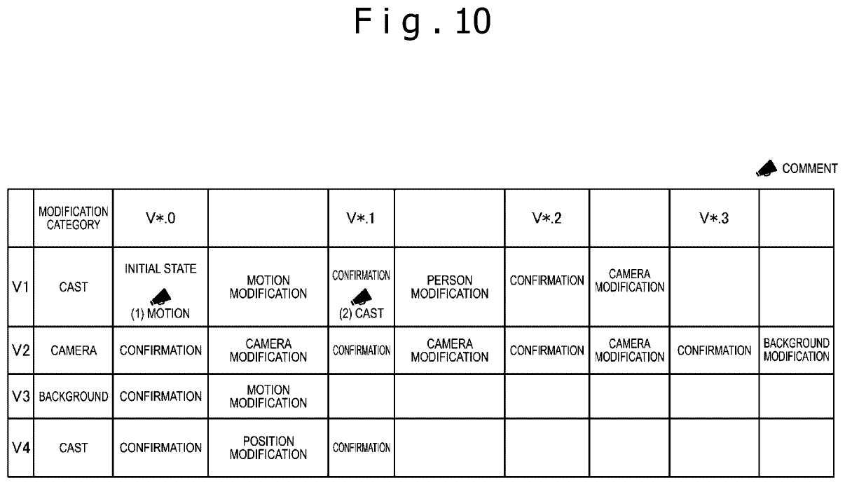

An example of determination processing of a comment level in the second configuration example of the comment categories in FIG. 9 will be described with reference to FIG. 10. FIG. 10 is a diagram illustrating another example of determining a comment level.

In FIG. 10, the information processing system 1 receives a comment of the comment category “motion (of cast)” on the moving image of Ver1.0 as indicated in “(1) motion”. That is, the information processing system 1 receives a comment having, as the comment category, the subcategory “motion” of the category “cast” on the moving image of Ver1.0.

Further, the information processing system 1 receives a modification of the modification category “motion (of cast)” to the moving image of Ver1.0, and updates the version of the moving image to Ver1.1. That is, the information processing system 1 receives a modification of the subcategory “motion” of the category “cast”, and updates the version of the moving image to Ver1.1.

In addition, as indicated by “(2) cast”, the information processing system 1 receives a comment of the comment category “cast” on the moving image of Ver1.1. That is, the information processing system 1 receives a comment having the category “cast” as the comment category on the moving image of Ver1.1.

Further, the information processing system 1 receives a modification of the modification category “person (of cast)” to the moving image of Ver1.1, and updates the version of the moving image to Ver1.2. That is, the information processing system 1 receives a modification of the subcategory “person” of the category “cast” to the moving image of Ver1.1, and updates the version of the moving image to Ver1.2.

Further, the information processing system 1 receives a modification of the modification category “camera” to the moving image of Ver1.2, and updates the version of the moving image to Ver2.0. Furthermore, the information processing system 1 receives a modification of the modification category “background” to the moving image of Ver2.3, and updates the version of the moving image to Ver3.0.

In addition, the information processing system 1 receives a modification of the modification category “motion (of cast)” to the moving image of Ver3.0, and updates the version of the moving image to Ver4.0. That is, the information processing system 1 receives a modification of the subcategory “motion” of the category “cast” to the moving image of Ver3.0, and updates the version of the moving image to Ver4.0.

Further, the information processing system 1 receives a modification of the modification category “position (of cast)” to the moving image of Ver4.0, and updates the version of the moving image to Ver4.1. That is, the information processing system 1 receives a modification of the subcategory “position” of the category “cast” to the moving image of Ver4.0, and updates the version of the moving image to Ver4.1.

Hereinafter, a method of calculating the comment level of each of (1) motion and (2) cast in FIG. 10 will be described. For example, the information processing system 1 may determine the comment level by the first calculation method using Equation (1) or the like. For example, in a case of a category (also referred to as a “target category”) to which a category (also referred to as a “lower category”) being at a lower level belongs, such as the category “cast”, the information processing system 1 may calculate the number of modifications corresponding to the target category by treating the modification of the lower category belonging to the target category as included in the number of modifications of the target category, and determine the number of modifications as the comment level of the comment.

For example, the information processing system 1 calculates the comment level of (1) motion by the first calculation method. When the first version is “4.1”, the information processing system 1 calculates the comment level of (1) motion as “2”. In addition, when the first version is “3.0”, the information processing system 1 calculates the comment level of (1) motion as “1”.

Further, for example, the information processing system 1 calculates each comment level of (2) cast by the first calculation method. When the first version is “4.1”, the information processing system 1 calculates the comment level of (2) cast as “3”. For example, the information processing system 1 calculates the total value “3” of the number of modifications including a modification of the subcategory “position” of the category “cast” of Ver4.0, a modification of the subcategory “motion” of the category “cast” of Ver3.0, and a modification of the subcategory “person” of the category “cast” of Ver1.1 as the comment level of (2) cast. In addition, when the first version is “3.0”, the information processing system 1 calculates the comment level of (2) cast as “1”.

In addition, for example, the information processing system 1 may determine the comment level by the second calculation method using Equation (2) or the like.

For example, the information processing system 1 calculates the comment level of (1) motion by the second calculation method. When the first version is “4.1”, the information processing system 1 calculates the comment level of (1) motion as “1.33” (=1*1/1+1*⅓). In addition, when the first version is “3.0”, the information processing system 1 calculates the comment level of (1) motion as “0.5” (=1*½).

Further, for example, the information processing system 1 calculates each comment level of (2) cast by the second calculation method. When the first version is “4.1”, the information processing system 1 calculates the comment level of (2) cast as “3.33” (=1*2+1*1/1+1*⅓). In addition, when the first version is “3.0”, the information processing system 1 calculates the comment level of (2) cast as “0.5” (=1*½).

### 1-4-2. Data Management Example

The information processing system 1 manages data in a mode in which the above-described processing can be executed. For example, the information processing system 1 manages various types of data to be used for processing in a mode as illustrated in FIG. 11. FIG. 11 is a diagram illustrating an example of data management. For example, FIG. 11 illustrates a case where the version is updated from V1.0 to V4.1.

The information processing system 1 may perform version management by using data as illustrated in FIG. 11. For example, the information processing system 1 holds the state of a specific version by a version management JSON (JavaScript Object Notation) file FL1. For example, a file of Ver2.1 (“Ver” may be abbreviated as “V”) includes a version management JSON file FL1 of V2.1, a JSON file FL2 of comments of V2.1, and the like. For example, a comment is stored together with a version name, time, an XY position of a video location, and a user name, such as the comment JSON file FL2.

For example, the information processing system 1 determines a comment on each version by using the version management JSON file and the comment JSON file. In the information processing system 1, data management as illustrated in FIG. 11 allows a video (moving image) to return to the state corresponding to a version in response to the designation of the version. Note that the data management illustrated in FIG. 11 is merely an example, and the information processing system 1 may manage data in any mode as long as desired processing can be executed. For example, each file illustrated in FIG. 11 is not limited to a file in which the state of a video is described, such as JSON, and may be a file of (information of) a difference between versions.

### 1-4-3. Processing Example According to Modification Categories

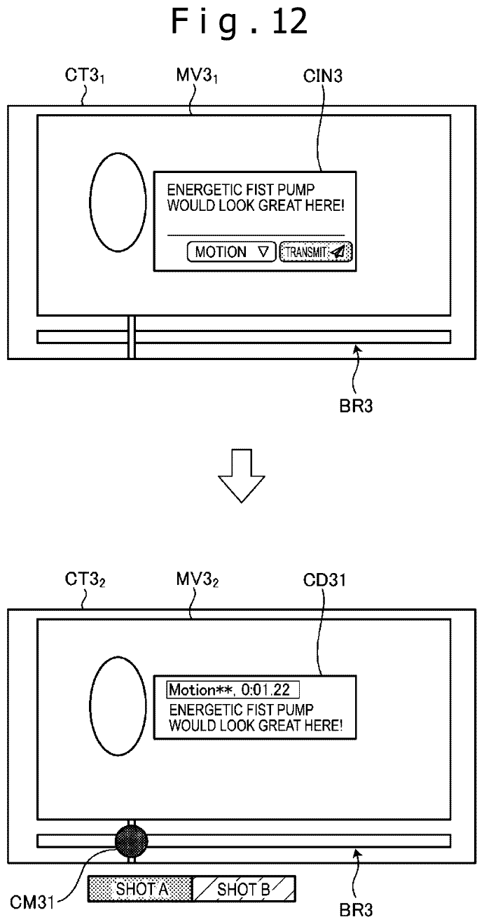

Here, an example of processing according to the modification categories will be described with reference to FIG. 12 to FIG. 14. FIG. 12 to FIG. 14 are diagrams illustrating an example of processing according to the modification categories.

In the example illustrated in FIG. 12, content CT3 including a moving image MV3, a seek bar BR3, and the like is illustrated as pieces of content CT31 to CT34 according to the transition of the display mode. Note that the pieces of content CT31 to CT34 and the like may be referred to as the content CT3 when the display mode and the like are not particularly distinguished in description. For example, in the information processing system 1, the client UI display section 400 displays the content CT3.

In addition, the moving image MV3 is illustrated as moving images MV3₁ to MV3₄ according to the addition of a comment, a modification, and the like. Note that the moving images MV3₁ to MV3₄ and the like may be referred to as the moving image MV3 when the moving images are not particularly distinguished in description.

First, an example of a modification for which a modification category is designated will be described with reference to FIG. 12. In the example illustrated in FIG. 12, the user designates a cast in the moving image MV3 (moving image MV3₁) being displayed, inputs a comment and the designation of a comment category in a comment input field CIN3 displayed in association with the designated cast, and selects the transmission button. Note that it is assumed that a person (cast) is included at the position of an ellipse in the moving image MV3 being displayed, although abstractly illustrated by the ellipse in FIG. 12.

For example, the information processing system 1 receives a comment category “motion (of cast)” and a comment “An energetic first pump would look great here!” in response to an operation of a user. In FIG. 12, a motion comment on a motion (of a cast) at a position (on the timeline) of the moving image MV3 corresponding to a position (on the timeline) at which a vertical bar in the seek bar BR3 is placed is received.

Thus, the information processing system 1 acquires information indicating the comment category “motion (of cast)” and the motion comment “An energetic first pump would look great here!”. For example, the information processing system 1 receives a motion comment on a motion at a position (on the timeline) of the moving image MV3 corresponding to a position (on the timeline) at which the comment icon CM31 of the seek bar BR3 is placed. For example, the motion comment “An energetic first pump would look great here!” is a comment added to the motion of the cast at time “0:01.22” in a shot A included in the moving image MV3. For example, the time “0:01.22” in the shot A is an elapsed time of the shot A from the start time point.

The information processing system 1 causes the display mode to transition from the content CT3₁ to the content CT3₂ in response to the reception of the motion comment. In FIG. 12, the information processing system 1 displays the content CT3₂ in which the comment icon CM31 corresponding to the motion comment is placed at a position on the seek bar BR3 corresponding to a position (on the timeline) of the moving image MV3 to which the motion comment is added. The information processing system 1 also displays the content CT3₂ in which comment-related information CD31 including the time “0:01.22” and the motion comment “An energetic first pump would look great here!” in the shot A is added on the moving image MV3₂.

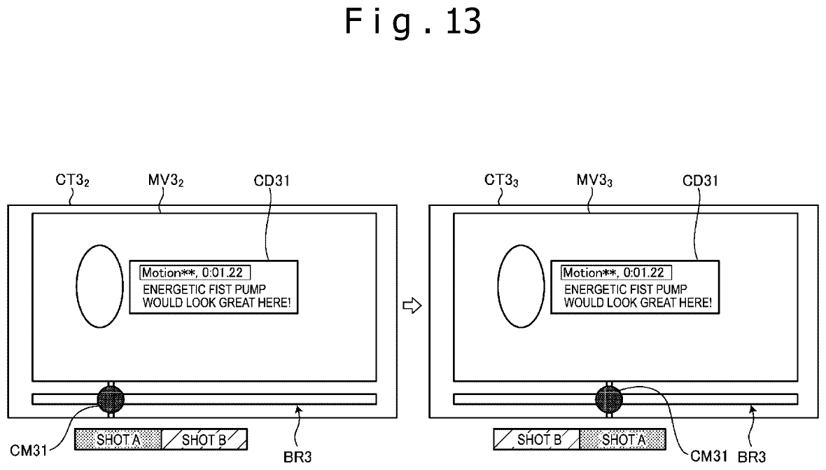

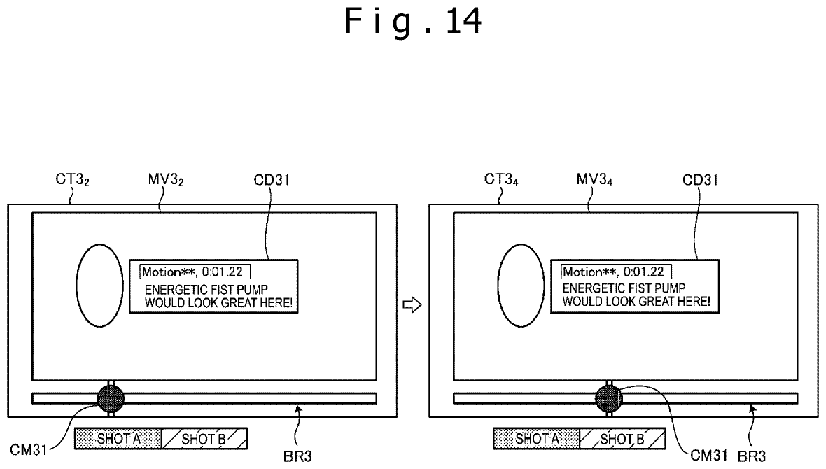

In this manner, when a comment is made on a motion, the information processing system 1 adds the comment according to, for example, the time of the motion in a shot. That is, in the information processing system 1, a comment may be added according to the time in each modification category, instead of being added to the time of the moving image. For example, the information processing system 1 adds a comment according to the elapsed time of each category in the shot. Thus, even when the shot itself is deleted or the front and back positions of the shot and another shot are swapped, or even when an element of the same category is used in another shot, the information processing system 1 can consistently associate the comment itself with an element of the selected category. Accordingly, the information processing system 1 can make it easy for a user to recognize what the comment refers to. This point will be described with reference to FIG. 13 and FIG. 14.

First, an example of swapping of shots will be described with reference to FIG. 13. The content CT3₂ in FIG. 13 is similar to the content CT3₂ in FIG. 12, and thus description thereof will be omitted. In the example illustrated in FIG. 13, the information processing system 1 receives an operation of swapping the shot A and a shot B in the moving image MV3. The information processing system 1 causes the display mode to transition from the content CT3₂ to the content CT3₃ in response to the reception of the operation of swapping the shot A and the shot B. In FIG. 13, the information processing system 1 displays the content CT3₃ in which the comment icon CM31 is placed at the position (on the timeline) changed in response to the swapping of the shot A and the shot B.

In this manner, the information processing system 1 can add the comment on the motion at the designated position even when the shot A and the shot B are swapped. The information processing system 1 also displays the content CT3₃ in which the comment-related information CD31 including the time “0:01.22” and the motion comment “An energetic first pump would look great here!” in the shot A is added on the moving image MV3₃.

First, an example of the use of a motion will be described with reference to FIG. 14. The content CT3₂ in FIG. 14 is similar to the content CT3₂ in FIG. 12, and thus description thereof will be omitted. In the example illustrated in FIG. 14, the information processing system 1 receives an operation of using a motion in the shot A in the moving image MV3 as a motion in the shot B. The information processing system 1 causes the display mode to transition from the content CT3₂ to the content CT3₄ in response to the reception of the operation of using the motion in the shot A as the motion in the shot B. In FIG. 14, the information processing system 1 displays the content CT3₄ in which the comment icon CM31 is placed at the position (on the timeline) changed in response to swapping of the shot A and the shot B.

In this manner, the information processing system 1 can take over the comment on the motion when the motion of the shot A is used in the shot B. The information processing system 1 also displays the content CT3₄ in which the comment-related information CD31 including the time “0:01.22” and the motion comment “An energetic first pump would look great here!” in the shot B is placed on the moving image MV3₄. Note that when the motion of the shot A is used without any change also in the shot A, the information processing system 1 may display the content CT3 in which the comment icon CM31 is placed also at a position corresponding to the shot A.

### 1-4-4. Display Example of Comments

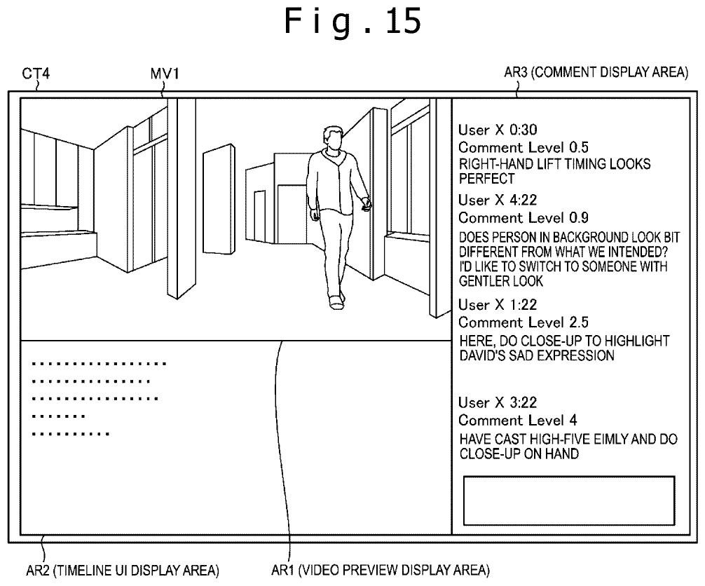

Note that the display mode of the comments is not limited to the above-described example, and may be any display mode. For example, the comment may be added and displayed on the timeline or may be added and displayed in another chat box. This point will be described with reference to FIG. 15. FIG. 15 is a diagram illustrating an example of the display mode of a comment.

In the example illustrated in FIG. 15, the information processing system 1 generates content CT4 including the moving image MV1 and the like. For example, in the information processing system 1, the client UI display section 400 displays the content CT4. The content CT4 includes a video preview display area AR1 for displaying a video preview screen such as the moving image MV1, a timeline UI display area AR2 for displaying a timeline UI screen, and a comment display area AR3 for displaying comments.

FIG. 15 illustrates a case where the information processing system 1 displays, in the comment display area AR3, comments aligned in the order of time of the moving image (video). Note that the comments may be aligned and displayed in any order, which is not limited to the order of time. For example, the information processing system 1 may display the comments aligned in an order based on the comment level of each comment. In this case, the information processing system 1 may display the comments aligned in descending order of the comment levels of the respective comments (for example, in ascending order of the values thereof).

### 1-4-5. Display Example of Version

Note that the display mode of the version is not limited to the above-described example, and may be any display mode. For example, the information processing system 1 may manage the version for each category and perform display according to a category designated by using a version history. In addition, various variations can be adopted as activation variations, variations in version presentation method, and the like. Several examples of the display mode of versions including these points will be described.

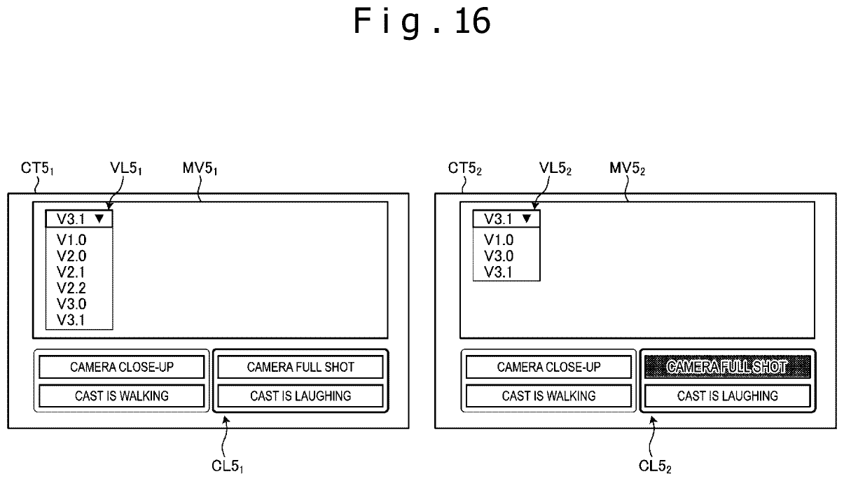

First, the example illustrated in FIG. 16 will be described. FIG. 16 is a diagram illustrating an example of the display mode of versions. The information processing system 1 may display the versions in a tab format as illustrated in version lists VL5₁ and VL5₂ in FIG. 16.

In addition, the information processing system 1 displays all versions when a specific shot is selected. In FIG. 16, when a specific shot is selected, the information processing system 1 displays a content CT5₁ in which the version list VL5₁ including all versions is placed on a moving image MV5₁. In this case, the information processing system 1 displays a content CT5₁ including a category list CL5₁, the version list VL5₁, and the moving image MV5₁.

Further, when a category is selected, the information processing system 1 displays only versions related to the category. In FIG. 16, when a hatched category in the category list CL5₂ is selected, the information processing system 1 displays the content CT5₂ in which the version list VL5₂ including only versions related to the category is placed on the moving image MV5₂.

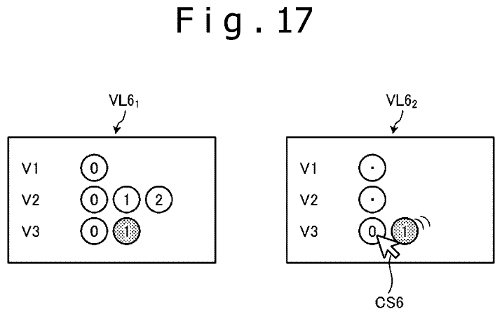

Next, an example illustrated in FIG. 17 will be described. FIG. 17 is a diagram illustrating an example of the display mode of versions. The information processing system 1 may display the versions in a list format as illustrated in version lists VL6₁ and VL6₂ in FIG. 17. For example, the information processing system 1 may display all the versions in a list as in the version list VL6₁. Further, the information processing system 1 may display the current version (the latest version or the like) in a different mode from those of the other versions as in the version list VL6₁. In FIG. 17, the different mode is indicated by hatching, but the different mode referred to here may be the fact that the color, size, shape, degree of transparency, and the like are different from the display of the other versions.

The information processing system 1 may display, only for a major version designated by a user, a minor version corresponding to the major version as in the version list VL6₂. For example, the information processing system 1 may display the minor version (V3.1 in FIG. 17) corresponding to V3.0 by a mouse hover, which means placing a mouse cursor CS6 over the icon corresponding to V3.0 in the version list VL6₂.

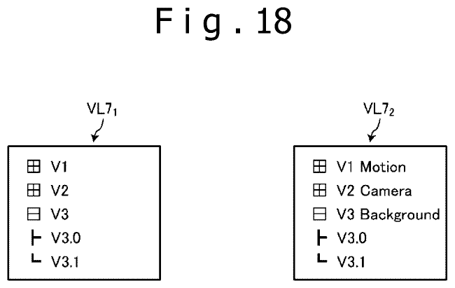

Next, an example illustrated in FIG. 18 will be described. FIG. 18 is a diagram illustrating an example of the display mode of versions. The information processing system 1 may display the versions in a tree structure as illustrated in version lists VL71 and VL72 in FIG. 18. For example, the information processing system 1 may display all the versions in a tree structure as in the version list VL71. For example, the information processing system 1 may display the versions in a tree structure in which the category name is denoted in the major version as in the version list VL72.

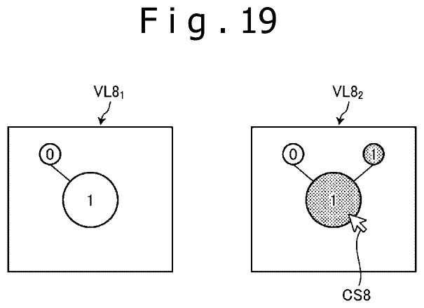

Next, an example illustrated in FIG. 19 will be described. FIG. 19 is a diagram illustrating an example of the display mode of versions. The information processing system 1 may display the versions in a bubble-style format as illustrated in version lists VL8₁ and VL8₂ in FIG. 18. For example, the information processing system 1 may display only the major versions in the bubble-style format as in the version list VL8₁. In addition, for example, the information processing system 1 may display a minor version corresponding to the major version designated by a user. For example, the information processing system 1 may display the minor version corresponding to V1.0 (V1.1 in FIG. 17) by a mouse hover, which means placing a mouse cursor CS8 over the icon corresponding to V1.0 in the version list VL8₂.

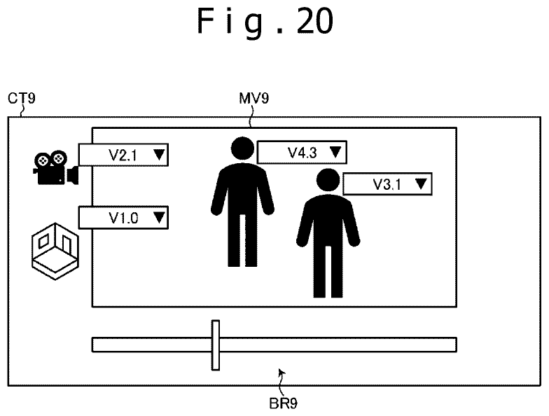

Next, an example illustrated in FIG. 20 will be described. FIG. 20 is a diagram illustrating an example of the display mode of versions. The information processing system 1 may display the version for each category as illustrated in content CT9. The content CT9 includes information indicating a moving image MV9, a seek bar BR9, and a version for each category. The content CT9 includes information indicating each category version, such as the version of the category “camera” (V2.1 in FIG. 20) and the version of each of a plurality of categories “cast” (V4.3, V3.1 in FIG. 20). Thus, in the information processing system 1, a user can check or change the version for each category.

### 1-5. AI Model

Note that each of the AI models used in the above-described processes is not limited to the examples described in the respective sections, and any structure can be adopted as the internal structure thereof as long as desired information can be output according to an input. Any combination of the inputs, the outputs, and the internal structures of the AI models may be adopted as long as desired information can be output.

The input of the AI model may be text, an image, a voice, 3D data, or the like, or a combination thereof. The output of the AI model may be text, an image, a voice, 3D data, or the like. Note that the above-described input and output are merely examples, and the above-described AI model may have any input and output.

In addition, as the internal structure of the AI model, any structure can be adopted according to the combination of the input and the output. That is, the internal structure of the AI model may be any structure as long as a desired output can be obtained with respect to an input.

For example, the AI model may have a structure related to Transformer. For example, the AI model may have a structure related to Transformer, and may perform processing in consideration of context such as a sequential relationship in data such as text and time-series data. For example, the AI model may have a self-attention mechanism. For example, the AI model may have any attention mechanism such as single-head attention, or multi-head attention. Note that the AI model does not necessarily have an attention mechanism.

The AI model may have a mechanism to extract features from an input. For example, the AI model may include an encoder. The AI model may have a mechanism for generating information based on the extracted features. For example, the AI model may include a decoder.

The AI model may have a structure related to a convolutional neural network (CNN). For example, the AI model may have a structure related to a CNN when performing processing on an image. For example, the AI model may include at least one of a convolutional layer, a pooling layer, a fully connected layer, and the like.

Note that the internal structure described above is merely an example, and the AI model described above may have any internal structure. For example, the AI model may have a skip connection. The AI model may have a structure related to a diffusion model.

Further, the AI model described above may be generated (trained) by any learning process. The AI model may be a machine learning model trained by using any machine learning method. For example, the AI model may be, based on a so-called foundation model, a model generated by fine-tuning the foundation model so as to apply the foundation model to a specific task (for example, generation of evaluation information, generation of proposal information, or the like). For example, the AI model such as the LLM described above may be a model generated by fine-tuning a foundation model so as to be applied to a specific task.

The foundation model referred to here is a model that has been trained so as to be applicable to various tasks, for example, so as to be capable of executing a wide variety of tasks. For example, the foundation model is a neural network that has been trained by using a large amount of unlabeled dataset. Note that the foundation model may have any structure such as a Transformer-based architecture. For example, the foundation model is generated by self-supervised learning using data without ground-truth labels. As described above, the foundation model is fine-tuned to be adaptable to a wide range of downstream tasks.

It should be noted that the above-described learning process is merely an example, and the above-described AI model is trained by any learning process according to the input, output, and internal structure of the AI model. For example, the AI model may be trained through an unsupervised learning method such as a generative adversarial network (GAN). Alternatively, the AI model may be trained in a state in which data is distributed without being aggregated as in federated learning or the like. In this case, each apparatus (server or the like) in video generation services may generate a local model collected in the service, and a server (aggregation server) that aggregates pieces of information (parameters or the like) of the local models generated by the respective apparatuses (servers or the like) in the video generation services may generate a global model by using the pieces of information of the local models. In this case, the information processing system 1 may receive, from the aggregation server, the global model generated by the aggregation server, and use the received global model as an AI model in processing.

In this way, the above-described AI model may be generated (trained) by any computer. That is, the learning process of generating the AI model may be performed by any apparatus (a computer or the like) of the information processing system 1 or may be performed by an apparatus outside the information processing system 1. For example, when an apparatus outside the information processing system 1 generates at least one of the above-described AI models, the information processing system 1 acquires the AI model from the apparatus outside the information processing system 1 and performs processing by using the acquired AI model.

### 2. Other Embodiments

The processing according to the above-described embodiment may be implemented in various different forms (modified examples) other than the above-described embodiment and modified example.

### 2-1. Other Configuration Examples

The configuration of the information processing system 1 described above is merely an example, and any form can be adopted for the division of the functions in the information processing system 1. That is, the above-described configuration is an example, and the information processing system 1 may have a division form of any function and any configuration as long as the above-described service related to video generation can be provided. For example, the information processing system 1 may be configured by one apparatus (a computer or the like) that performs the above-described processing. In this case, one apparatus of the information processing system 1 may have the functions of the video generation module 100, the information acquisition module 200, the sensor unit 300, and the client UI display section 400. For example, the video generation service provided by the information processing system 1 may be provided to a user as a program such as a tool (AI assist creation tool) that operates on a terminal apparatus (the computer 20 or the like) used by the user.

### 2-2. Others

Further, among the processing operations described in the above-described embodiment, all or some of the processing operations described as being automatically performed may be manually performed, or all or some of the processing operations described as being manually performed may be automatically performed by a known method. In addition, the processing procedures, specific names, and information including various data and parameters described in the above document and drawings can be arbitrarily changed unless otherwise specified. For example, the various types of information illustrated in the drawings are not limited to the illustrated information.

The components of the devices illustrated in the drawings are functionally conceptual and are not necessarily physically configured as illustrated in the drawings. That is, specific embodiments of distribution and integration of the respective devices are not limited to those illustrated in the drawings, and all or part of each device can be functionally or physically distributed or integrated in any unit according to various loads, usage conditions, or the like.

Further, the embodiment and the modified examples described above can be combined as appropriate as long as the processing contents do not contradict each other.

In addition, the effects described in the present specification are merely examples and are not limited, and other effects may be obtained.

### 3. Hardware Configuration

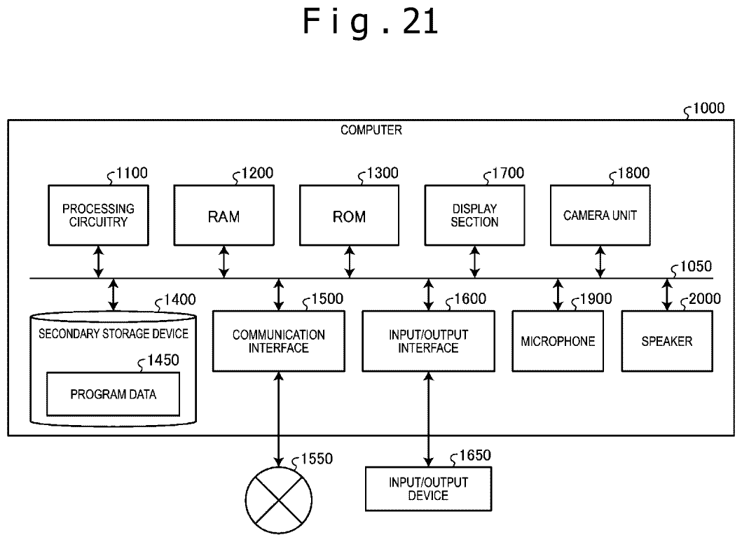

An information processing apparatus (information device) including the video generation module 100, the information acquisition module 200, and the client UI display section 400, and the like according to the above-described embodiment is implemented by a computer 1000 having a configuration illustrated in FIG. 21, for example. An information processing apparatus including the video generation module 100 will be described as an example. FIG. 21 is a hardware configuration diagram illustrating an example of a computer that enables the functions of the information processing apparatus. The computer 1000 includes processing circuitry 1100, a RAM 1200, a ROM 1300, a secondary storage device 1400, a communication interface 1500, and an input/output interface 1600, a display section 1700, a camera unit 1800, a microphone 1900, and a speaker 2000. The units of the computer 1000 are connected together via a bus 1050.

The processing circuitry 1100 operates based on a program stored in the ROM 1300 or the secondary storage device 1400, and controls each unit. For example, the processing circuitry 1100 loads a program stored in the ROM 1300 or the secondary storage device 1400 onto the RAM 1200 and executes processing corresponding to the various types of programs.

The ROM 1300 stores a boot program such as a basic input output system (BIOS) to be executed by the processing circuitry 1100 at the time of activation of the computer 1000, a program depending on hardware of the computer 1000, and the like.

The secondary storage device 1400 is a computer-readable recording medium that stores, in a non-transitory manner, a program to be executed by the processing circuitry 1100, data to be used by the program, and the like. Specifically, the secondary storage device 1400 is a recording medium that records programs for the processes in the information processing apparatus including the video generation module 100 according to the embodiment, which is an example of program data 1450.

The communication interface 1500 is an interface used for connecting the computer 1000 to an external network 1550. The communication interface 1500 corresponds to a communication unit (communication device) included in the information processing apparatus including the video generation module 100. For example, the processing circuitry 1100 receives data from another device via the communication interface 1500 and transmits data generated by the processing circuitry 1100 to another device via the communication interface 1500.

The input/output interface 1600 is an interface for connecting the input/output device 1650 and the computer 1000. For example, the processing circuitry 1100 receives data from input devices such as the microphone 1900 and a touch panel via the input/output interface 1600. The processing circuitry 1100 also transmits data to output devices such as the display section 1700 and the speaker 2000 via the input/output interface 1600. In addition, the input/output interface 1600 may function as a media interface that reads a program or the like recorded in a predetermined recording medium. The medium refers to an optical recording medium such as a digital versatile disc (DVD) or a phase change rewritable disk (PD), a magneto-optical recording medium such as a magneto-optical disk (MO), a tape medium, a magnetic recording medium, or a semiconductor memory.

The display section 1700 is an interface for displaying information processed by the computer 1000. The display section 1700 is, for example, a liquid crystal display or an organic electro luminescence display (organic EL display). Alternatively, the display section 1700 may be a touch panel type display device or a video projection device.

The camera unit 1800 is an interface for the computer 1000 to capture an image. The microphone 1900 is an interface for the computer 1000 to capture audio. The speaker 2000 is an interface for outputting audio processed by the computer 1000. The units of the computer 1000 are connected together via the bus 1050. Each interface is not necessarily provided inside the computer 1000, and may be provided outside the computer 1000 through a network or the like. In addition, the components included in the computer 1000 may be controlled by a circuit different from the processing circuitry 1100. For example, the display section 1700 may be controlled by a circuit dedicated to display processing included in the display section 1700, instead of the processing circuitry 1100.

For example, when the computer 1000 functions as the information processing apparatus including the video generation module 100 according to the embodiment, the processing circuitry 1100 of the computer 1000 executes a program loaded onto the RAM 1200 to function as the video generation module 100. Furthermore, the secondary storage device 1400 stores an information processing program according to the embodiment of the present disclosure and various types of data stored in the storage unit of the information processing apparatus. Note that the processing circuitry 1100 reads and executes the program data 1450 from the secondary storage device 1400. However, in another example, the processing circuitry 1100 may acquire these programs from another apparatus via the external network 1550. That is, the secondary storage device 1400 is not limited to being inside the computer 1000, and may be placed outside the computer 1000. It should be noted that the processing circuitry 1100 is an example of an integrated circuit, and all of a CPU, an MPU, a GPU, an APU, an ASIC, and an FPGA can be regarded as integrated circuits.

Note that the present technology can also adopt configurations such as the following.

(1)

An information processing system including:
an acquisition unit that acquires comment information indicating a category of a comment added to a moving image and version information indicating a first version that is a version of the moving image;
a determination unit that determines a level of the comment, based on the category of the comment and the first version of the moving image; and
an output unit that outputs comment display information indicating the comment whose display is changed according to the level.
   (2)

The information processing system according to (1), wherein
the first version is a version of the moving image when the moving image is displayed.
   (3)

The information processing system according to (1) or (2), wherein
the first version is a latest version of the moving image.
   (4)

The information processing system according to any one of (1) to (3), wherein
the determination unit determines the level of the comment according to a difference between a second version and the first version, the second version being a version of the moving image when the comment is added.
   (5)

The information processing system according to (4), wherein
the determination unit determines the level of the comment, based on a modification of the moving image corresponding to the category between the second version and the first version.
   (6)

The information processing system according to (5), wherein
the determination unit determines the level of the comment, based on the number of modifications of the moving image corresponding to the category between the second version and the first version.
   (7)

The information processing system according to (6), wherein
the determination unit determines the level of the comment based on the number of modifications corresponding to the category in a period from the second version to the first version, the second version being a version before the first version.
   (8)

The information processing system according to (6) or (7), wherein
the determination unit determines the number of modifications corresponding to the category as the level of the comment.
   (9)

The information processing system according to any one of (5) to (7), wherein
the determination unit determines the level of the comment, based on a third version that is a version in which a modification corresponding to the category is made.
   (10)

The information processing system according to (9), wherein
the determination unit determines the level of the comment, based on a weight corresponding to a difference between the first version and the third version.
   (11)

The information processing system according to (10), wherein
the determination unit determines the level of the comment by using a calculation value calculated based on the weight corresponding to the difference between the first version and the third version and the number of modifications corresponding to the category in the third version.
   (12)

The information processing system according to any one of (1) to (11), wherein
the version of the moving image is updated in response to a modification to the moving image.
   (13)

The information processing system according to (12), wherein
when a modification related to a different category is made, a major version at a highest-order level of the version of the moving image is updated, and
when a modification related to an identical category is made, a minor version at a lower-order level relative to the major version is updated.
   (14)

The information processing system according to any one of (1) to (13), wherein
the comment is added corresponding to an elapsed time of each category in a shot of the moving image.
   (15)

The information processing system according to any one of (1) to (14), wherein
the category is any one of a plurality of categories including an entirety, a cast, a motion, a hand, a cast position, a camera framing, a camera motion, a background, and sound.
   (16)

The information processing system according to any one of (1) to (15), wherein
the category is any one of a plurality of categories hierarchically structured according to a concept of each category.
   (17)

The information processing system according to any one of (1) to (16), wherein
the output unit outputs content including the comment display information and the moving image.
   (18)

The information processing system according to any one of (1) to (17), wherein
the output unit displays the comment display information together with the moving image.
   (19)

An information processing method including:
acquiring comment information indicating a category of a comment added to a moving image and version information indicating a first version that is a version of the moving image;
determining a level of the comment, based on the category of the comment and the first version of the moving image; and
outputting comment display information indicating the comment whose display is changed according to the level.
   (20)

An information processing program that causes a computer to execute:
acquiring comment information indicating a category of a comment added to a moving image and version information indicating a first version that is a version of the moving image;
determining a level of the comment, based on the category of the comment and the first version of the moving image; and
outputting comment display information indicating the comment whose display is changed according to the level.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

1 Information processing system
100 Video generation module
110 Information analysis unit
115 Sensor analysis unit
120 Prompt and related information generation unit
121 Scenario-oriented generation unit
122 Video-oriented generation unit
123 Sound-oriented generation unit
124 Text/logo-oriented generation unit
130 Management processing unit
131 Acquisition unit
132 Information management unit
133 Determination unit
134 Output unit
140 Video generation unit
141 USD generation unit
142 Rendering unit
143 Video enhancement unit
150 Sound generation unit
160 Text/logo generation unit
170 Composite editing unit
180 Evaluation unit
190 Client UI module
200 Information acquisition module
210 Information acquisition unit
220 Sensor acquisition unit
300 Sensor unit
400 Client UI display section

1. An information processing system comprising:
an acquisition unit that acquires comment information indicating a category of a comment added to a moving image and version information indicating a first version that is a version of the moving image;
a determination unit that determines a level of the comment, based on the category of the comment and the first version of the moving image; and
an output unit that outputs comment display information indicating the comment whose display is changed according to the level.

2. The information processing system according to claim 1, wherein
the first version is a version of the moving image when the moving image is displayed.

3. The information processing system according to claim 1, wherein
the first version is a latest version of the moving image.

4. The information processing system according to claim 1, wherein
the determination unit determines the level of the comment according to a difference between a second version and the first version, the second version being a version of the moving image when the comment is added.

5. The information processing system according to claim 4, wherein
the determination unit determines the level of the comment, based on a modification of the moving image corresponding to the category between the second version and the first version.

6. The information processing system according to claim 5, wherein
the determination unit determines the level of the comment, based on the number of modifications of the moving image corresponding to the category between the second version and the first version.

7. The information processing system according to claim 6, wherein
the determination unit determines the level of the comment, based on the number of modifications corresponding to the category in a period from the second version to the first version, the second version being a version before the first version.

8. The information processing system according to claim 6, wherein
the determination unit determines the number of modifications corresponding to the category as the level of the comment.

9. The information processing system according to claim 5, wherein
the determination unit determines the level of the comment, based on a third version that is a version in which a modification corresponding to the category is made.

10. The information processing system according to claim 9, wherein
the determination unit determines the level of the comment, based on a weight corresponding to a difference between the first version and the third version.

11. The information processing system according to claim 10, wherein
the determination unit determines the level of the comment by using a calculation value calculated based on the weight corresponding to the difference between the first version and the third version and the number of modifications corresponding to the category in the third version.

12. The information processing system according to claim 1, wherein
the version of the moving image is updated in response to a modification to the moving image.

13. The information processing system according to claim 12, wherein
when a modification related to a different category is made, a major version at a highest-order level of the version of the moving image is updated, and
when a modification related to an identical category is made, a minor version at a lower-order level relative to the major version is updated.

14. The information processing system according to claim 1, wherein
the comment is added corresponding to an elapsed time of each category in a shot of the moving image.

15. The information processing system according to claim 1, wherein
the category is any one of a plurality of categories including an entirety, a cast, a motion, a hand, a cast position, a camera framing, a camera motion, a background, and sound.

16. The information processing system according to claim 1, wherein
the category is any one of a plurality of categories hierarchically structured according to a concept of each category.

17. The information processing system according to claim 1, wherein
the output unit outputs content including the comment display information and the moving image.

18. The information processing system according to claim 1, wherein
the output unit displays the comment display information together with the moving image.

19. An information processing method comprising:
acquiring comment information indicating a category of a comment added to a moving image and version information indicating a first version that is a version of the moving image;
determining a level of the comment, based on the category of the comment and the first version of the moving image; and
outputting comment display information indicating the comment whose display is changed according to the level.

20. An information processing program that causes a computer to execute:
acquiring comment information indicating a category of a comment added to a moving image and version information indicating a first version that is a version of the moving image;
determining a level of the comment, based on the category of the comment and the first version of the moving image; and
outputting comment display information indicating the comment whose display is changed according to the level.
